(19) United States
(12) Patent Application Publication
(10) Pub. No.: US 2025/0373596 A1
(43) Pub. Date: Dec. 4, 2025

(54) Orchestrating Testing Of Digital Certificates In An Execution Environment Of A Computing Network

(71) Applicant: Oracle International Corporation, Redwood Shores, CA (US)

(72) Inventors: Hao Wang, Mountlake Terrace, WA (US); Bernardo Rivas Carrillo, Kenmore, WA (US); Thoulfekar Alrahem, Bend, OR (US)

(73) Assignee: Oracle International Corporation, Redwood Shores, CA (US)

(21) Appl. No.: 18/675,494

(22) Filed: May 28, 2024

(51) Int. Cl. H04L 9/40

(52) U.S. Cl. CPC H04L 63/0823

(57) ABSTRACT

A system orchestrates a testing process for testing a new certificate authority (CA) certificate in an execution environment prior to the new CA certificate superseding a current CA certificate in the execution environment. Orchestrating the testing process includes issuing a first entity certificate based on the new CA certificate for a first network entity executing in the execution environment that is designated for performing testing operations and distributing the first entity certificate to the first network entity for performing the testing operations. While performing the testing operations, the system distributes a second entity certificate, issued based on the current CA certificate, to a second network entity executing in the execution environment that is not designated for performing testing operations. The system removes the current CA certificate from the execution environment responsive to determining that the testing operations are successful, and the new CA certificate supersedes the current CA certificate.

### TECHNICAL FIELD

The present disclosure relates to distribution of digital certificates to network entities of a computing network. More particularly, the present disclosure relates to testing the digital certificates in connection with distribution of digital certificates to the network entities.

### BACKGROUND

A computing network, such as a virtual cloud network, includes network entities that communicate with one another. Communications between network entities may be performed in accordance with a security protocol, whereby network entities authenticate one another by presenting a digital certificate. A digital certificate may be issued for a network entity by a certificate authority (CA). The digital certificate includes a digital signature generated using a private key of the CA that issued the digital certificate. The digital signature can be validated using a CA certificate of the CA that includes a public key corresponding to the private key. When a network entity presents a valid digital certificate to another network entity, the other network entity can trust that it is communicating with the network entity, as opposed to some unknown entity, based on a trust relationship with a CA that issued the digital certificate.

A certificate bundle includes a set of CA certificates for validating digital certificates issued for network entities. The certificate bundle is distributed to network entities throughout the computing network. New digital certificates are periodically issued for network entities. In some instances, the new digital certificates are issued based on a new CA certificate that supersedes a previous CA certificate. Additionally, a new certificate bundle that includes the new CA certificate is distributed to network entities throughout the computing network for authenticating the new digital certificates issued based on the new CA certificate.

The content of this background section should not be construed as prior art merely by virtue of its presence in this section.

### BRIEF DESCRIPTION OF THE DRAWINGS

The embodiments are illustrated by way of example and not by way of limitation in

the figures of the accompanying drawings. References to “an” or “one” embodiment in this disclosure are not necessarily to the same embodiment and refer to at least one embodiment. In the drawings:

FIGS. 1-4 are block diagrams illustrating patterns for implementing a cloud infrastructure as a service system in accordance with one or more embodiments;

FIG. 5 is a hardware system in accordance with one or more embodiments;

FIGS. 6A-6E illustrate features of an example system in accordance with one or more embodiments;

FIG. 7 is a flowchart that illustrates operations pertaining to an example certificate distribution process in accordance with one or more embodiments;

FIG. 8 is a flowchart that illustrates operations pertaining to an example process for distributing entity certificates to network entities in accordance with one or more embodiments;

FIG. 9 is a flowchart that illustrates example operations pertaining to selecting a CA certificate for issuance of an entity certificate to a network entity in accordance with one or more embodiments; and

FIG. 10 is a flowchart that illustrates an example operations for orchestrating a testing process for performing testing operations pertaining to a new CA certificate in an execution environment of a computing network in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

1. GENERAL OVERVIEW

2. PRACTICAL APPLICATIONS, ADVANTAGES, & IMPROVEMENTS

3. AUTHENTICATING NETWORK ENTITIES

4. CLOUD COMPUTING TECHNOLOGY

5. COMPUTER SYSTEM

6. ARCHITECTURAL OVERVIEW

7. EXAMPLE CERTIFICATE DISTRIBUTION AND PROCESSES

8. MISCELLANEOUS; EXTENSIONS

### 1. General Overview

One or more embodiments orchestrate testing processes for performing testing operations pertaining to distribution of new artifacts to network entities in an execution environment of a computing network while a current artifact is active in the execution environment. The artifacts may include digital certificates. Additionally, or alternatively, the artifacts may include certificate bundles that include CA certificates. In one example, a system orchestrates testing processes for performing testing operations pertaining to distribution of a new CA certificate in an execution environment of a computing network while a current CA certificate is active in the execution environment. The testing operations pertaining to the new CA certificate are performed prior to the new CA certificate superseding a current CA certificate in the execution environment. Orchestrating the testing process includes issuing a first entity certificate based on the new CA certificate for a first network entity executing in the execution environment that is designated for performing testing operations and distributing the first entity certificate to the first network entity for performing the testing operations. While performing the testing operations, the system distributes a second entity certificate, issued based on the current CA certificate, to a second network entity executing in the execution environment that is not designated for performing testing operations. The system removes the current CA certificate from the execution environment responsive to determining that the testing operations are successful, and the new CA certificate supersedes the current CA certificate.

In one example, the testing process may include installing the new CA certificate in a first portion of the execution environment and issuing a first entity certificate to a first network entity located in the first portion of the execution environment based on the new CA certificate. The new CA certificate may be installed in the first portion of the execution environment while the current CA certificate is installed in a second portion of the execution environment. In one example, both the new CA and the current CA may be installed in the first portion of the execution environment. The new CA may be provided to the first portion of the execution environment via a certificate bundle. In one example, the certificate bundle may include the new CA certificate and the current CA certificate. The testing operations may be performed with respect to the first network entity while the current CA certificate is installed in a second portion of the execution environment. In response to determining that the one or more testing operations are successful, the system may install the new CA certificate in the second portion of the execution environment.

In one example, the testing operations may include validating that the first entity certificate is successfully issued and distributed to the first network entity. Additionally, alternatively, the testing operations may include validating that the first entity certificate issued based on the new CA certificate is successfully authenticated via the new CA certificate. Additionally, or alternatively, the testing operations may include the first network entity transmitting the first entity certificate to a third network entity for authentication against the new CA certificate. Further, the testing operations may include the third network entity executing an authentication protocol for authenticating the first entity certificate against the new CA certificate.

In one example, the system maintains the new CA certificate and the current CA certificate in an active state in the execution environment while performing the testing operations pertaining to the new CA certificate. To maintain the new CA certificate and the current CA certificate in the active state in the execution environment, the system stores the new CA certificate and the current CA certificate in a certificate repository for issuance of new entity certificates to network entities executing in the execution environment. The system issues a first entity certificate for a first network entity based on the new CA certificate stored in the certificate repository while the current CA certificate is stored in the certificate repository. Additionally, the system issues a second entity certificate for a second network entity based on the current CA certificate stored in the certificate repository while the new CA certificate is stored in the certificate repository.

One or more embodiments described in this Specification and/or recited in the claims may not be included in this General Overview section.

### 2. Practical Applications, Advantages & Improvements

One or more embodiments utilize the testing operations performed in the execution environment of the computing network to validate that systems and operations of the computing network are functioning properly with a new artifact (e.g., a new CA certificate) prior to the new artifact (e.g., the new CA certificate) superseding a current artifact (e.g., a current CA certificate). The system may execute the testing operations to confirm that various systems and operations of the execution environment are operating properly with the new CA certificate and entity certificates issued from the new CA certificate. Additionally, or alternatively, the system may identify issues associated with the new CA certificate and/or the entity certificates issued from the new CA certificate prior to removing the current CA certificate from the execution environment. Further, the system may avoid downtime, assess operational performance, mitigate security risks, and maintain compliance with security protocols.

In one example, current CA certificates may be periodically replaced with a new CA certificate. A certificate distribution process for replacing a current CA certificate with a new CA certificate may be initiated according to a predefined schedule or in response to a trigger event, such as a security vulnerability, a system upgrade, a change to a security protocol, or an operator input. Replacement of CA certificates on a more frequent basis and/or in response to an increased set of trigger conditions may enhance the security posture of the computing network.

In one example, the system provides an automated process for distributing a new CA certificate that supersedes a current CA certificate in the execution environment. The automated process may facilitate a more expedient certificate distribution process, reduce the potential for service disruptions, and improve system security and performance.

### 3. Authenticating Network Entities

Network entities may utilize the CA certificates to authenticate other network entities associated with the virtual cloud network. The CA certificates that are utilized to authenticate network entities may be stored in a certificate bundle. In one example, communications between network entities may be conducted according to a security protocol. The security protocol may include authenticating a network entity based on an entity certificate issued for the network entity by a CA, for example, prior to establishing communications with the network entity.

In one example, the entity certificate and a CA certificate corresponding to the CA that issued the entity certificate may represent at least a portion of a certificate chain. The certificate chain may include the CA certificate and the entity certificate issued by the CA based on the CA certificate. Additionally, or alternatively, the certificate chain may include a root CA certificate, an intermediate CA certificate, and an entity certificate. To authenticate the network entity, one or more signature-key pairs in the certificate chain are validated.

In one example, a top-level CA may issue the entity certificate. In this case, the certificate chain may include one signature-key pair-that is, the digital signature of the top-level CA in the entity certificate and the public key of the top-level CA. Such a top-level CA is sometimes referred to as a root CA. In another example, the certificate chain may include signature-key pairs corresponding to multiple CA certificates. For example, a root CA may issue an intermediate CA certificate to an intermediate CA, and the intermediate CA may issue the entity certificate to the network entity. In this case, the certificate chain includes two signature-key pairs—that is, (i) the digital signature of the intermediate CA in the entity certificate and the public key of the intermediate CA, and (ii) the digital signature of the root CA in the intermediate CA certificate and the public key of the root CA.

As used herein, the term “certificate bundle” refers to a dataset that includes one or more CA certificates.

As used herein, the term “certificate authority certificate” or “CA certificate” refers to a digital certificate issued by a certificate authority to establish its own identity and authenticity. A certificate authority certificate may be a root CA certificate or an intermediate CA certificate. A certificate authority certificate may be used to sign and issue other digital certificates including those used for secure communication between network entities.

As used herein, the term “certificate authority” or “CA” refers to an entity responsible for issuing and managing digital certificates. The certificate authority verifies the identity of network entities and digitally signs their certificates to attest to their authenticity.

As used herein, the term “root certificate authority certificate” or “root CA certificate” refers to a top-level CA certificate in a certificate chain or hierarchy. A root CA certificate may be self-issued and/or self-signed by a root certificate authority. As used herein, the term “root CA” refers to a top-level CA in a CA hierarchy. A root CA may issue root CA certificates, intermediate CA certificates, or entity certificates.

As used herein, the term “intermediate certificate authority certificate” or “intermediate CA certificate” refers to an intermediate-level CA certificate in a certificate chain or hierarchy. An intermediate CA certificate may be issued by a root certificate authority. An intermediate CA certificate is located between a root CA certificate and an entity certificate in a certificate chain or hierarchy. As used herein, the term “intermediate CA” refers to an intermediate-level CA in a CA hierarchy. An intermediate CA may issue entity certificates, for example, pursuant to authority granted to an intermediate certificate authority according to a root certificate authority.

As used herein, the term “entity certificate” refers to a digital certificate issued for an entity such as a network entity associated with a virtual cloud network. An entity certificate may be used to verify the identity of the entity and enable secure communication between entities such as between network entities in a virtual cloud network. An entity certificate may be issued by a certificate authority, such as root CA or an intermediate certificate authority.

As used herein, the term “network entity” refers to a device, component, or element within a computer network and/or cloud infrastructure. A network entity may include a server, a client, an agent, a service, a component, an endpoint, or other element. A network entity may be implemented in hardware and/or software. A network entity may include a production service, such as a database service, an application hosting service, a networking service, a security service, an identity and access management service, a key management service, a backup service, a container orchestration service, a virtual machine service, or a content delivery service. A “server network entity” refers to a network entity that hosts one or more client network entities. A server network entity may include a physical or virtual machine, a physical or virtual server, a compute instance, a container, or a serverless computing resources. A “client network entity” refers to a network entity that accesses resources or services provided by a server network entity. A client network entity may include a container, a service, a resource, a component, a device. In one example, a server network entity is a virtual machine or a compute instance, and a client network entity is a container or a service executing on the virtual machine or compute instance. In one example, a network entity may act as both a server network entity and a client network entity depending on the perspective and the specific interactions taking place.

In one example, an entity certificate may be an instance principal certificate. As used herein, the term “instance principal certificate” refers to a digital certificate used to authenticate and secure communication for an instance or VM associated with a virtual cloud network. In one example, instances and VMs may be created, scaled, and terminated dynamically. Instance principal certificates may be associated with an instance or VM during its lifecycle and may be automatically generated and managed by the virtual cloud network infrastructure. An instance principal certificate may provide limited access to communicate with certain network entities. For example, an instance principal may be issued for a network entity, and the limited access of the instance principal may be based on permissions assigned to the network entity.

As used herein, the term “digital certificate” refers to a digitally signed electronic document that binds a public key to the identity of an entity. A digital certificate may conform to International Telecommunication Union standard X.509. A digital certificate may include an issuer's name, a certificate holder's name, a public key, issuer (CA) information, and an expiration date. Digital certificates may be used in various security protocols, such as SSL/TLS, to establish the identity and authenticity of the communicating parties and facilitate secure communication.

### 4. Cloud Computing Technology

Infrastructure as a Service (IaaS) is an application of cloud computing technology. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components; example services include billing software, monitoring software, logging software, load balancing software, clustering software, etc. Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on the VMs, deploy middleware such as databases, create storage buckets for workloads and backups, and install enterprise software into that VM. Customers can then use the provider's services to perform various functions, including balancing network traffic, troubleshooting application issues, monitoring performance, and managing disaster recovery, etc.

In some cases, a cloud computing model will involve the participation of a cloud provider. The cloud provider may, but need not, be a third-party service that specializes in providing (e.g., offering, renting, selling) IaaS. An entity may also opt to deploy a private cloud, becoming its own provider of infrastructure services.

In some examples, IaaS deployment is the process of implementing a new application, or a new version of an application, onto a prepared application server or other similar device. IaaS deployment may also include the process of preparing the server (e.g., installing libraries, daemons, etc.). The deployment process is often managed by the cloud provider below the hypervisor layer (e.g., the servers, storage, network hardware, and virtualization). Thus, the customer may be responsible for handling (OS), middleware, and/or application deployment such as on self-service virtual machines. The self-service virtual machines can be spun up on demand.

In some examples, IaaS provisioning may refer to acquiring computers or virtual hosts for use, even installing needed libraries or services on them. In most cases, deployment does not include provisioning, and the provisioning may need to be performed first.

In some cases, there are challenges for IaaS provisioning. There is an initial challenge of provisioning the initial set of infrastructure. There is an additional challenge of evolving the existing infrastructure (e.g., adding new services, changing services, removing services, etc.) after the initial provisioning is completed. In some cases, these challenges may be addressed by enabling the configuration of the infrastructure to be defined declaratively. In other words, the infrastructure (e.g., what components are needed and how components interact) can be defined by one or more configuration files. Thus, the overall topology of the infrastructure (e.g., what resources depend on one another and how resources work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). In some embodiments, infrastructure and resources may be provisioned (manually and/or using a provisioning tool) prior to deployment of code to be executed on the infrastructure. However, in some examples, the infrastructure that will deploy the code may first be set up. In some instances, the provisioning can be done manually, a provisioning tool may be utilized to provision the resources, and/or deployment tools may be utilized to deploy the code once the infrastructure is provisioned.

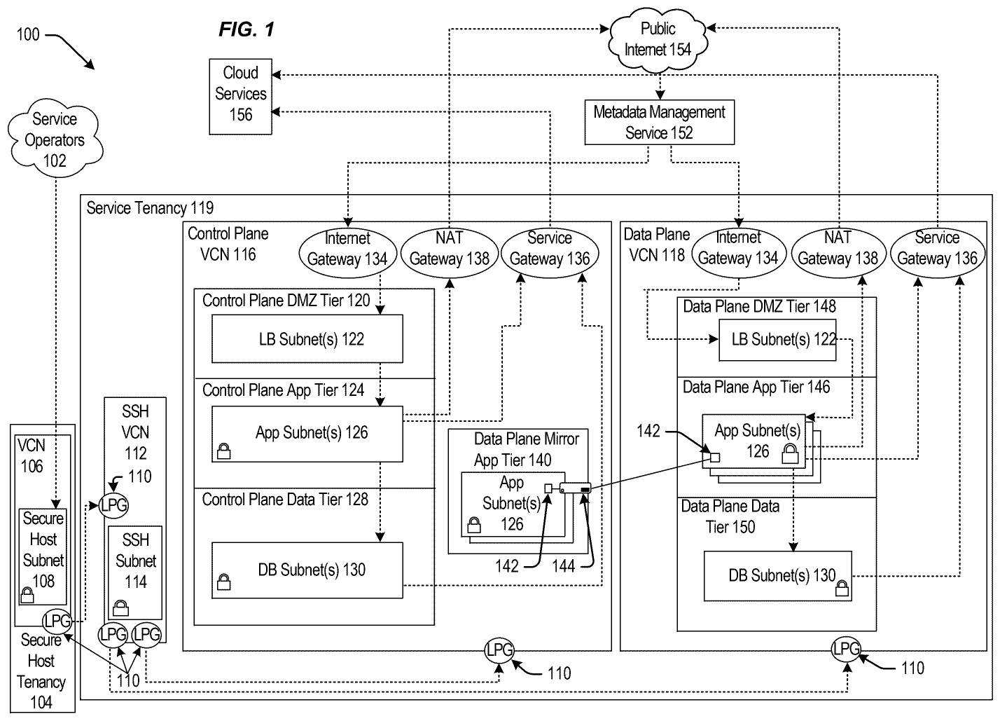

FIG. 1 is a block diagram illustrating an example pattern of an IaaS architecture 100 according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, such as portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers, including personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems such as Google Chrome OS. Additionally, or alternatively, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116. The app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way; the service gateway 136 can make API calls to cloud services 156, and cloud services 156 can send requested data to the service gateway 136. However, cloud services 156 may not initiate API calls to the service gateway 136.

In some examples, the secure host tenancy 104 can be directly connected to the service tenancy 119. The service tenancy 119 may otherwise be isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118. The control plane VCN 116 and the data plane VCN 118 may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154 for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119. The service tenancy 119 may be isolated from public Internet 154.

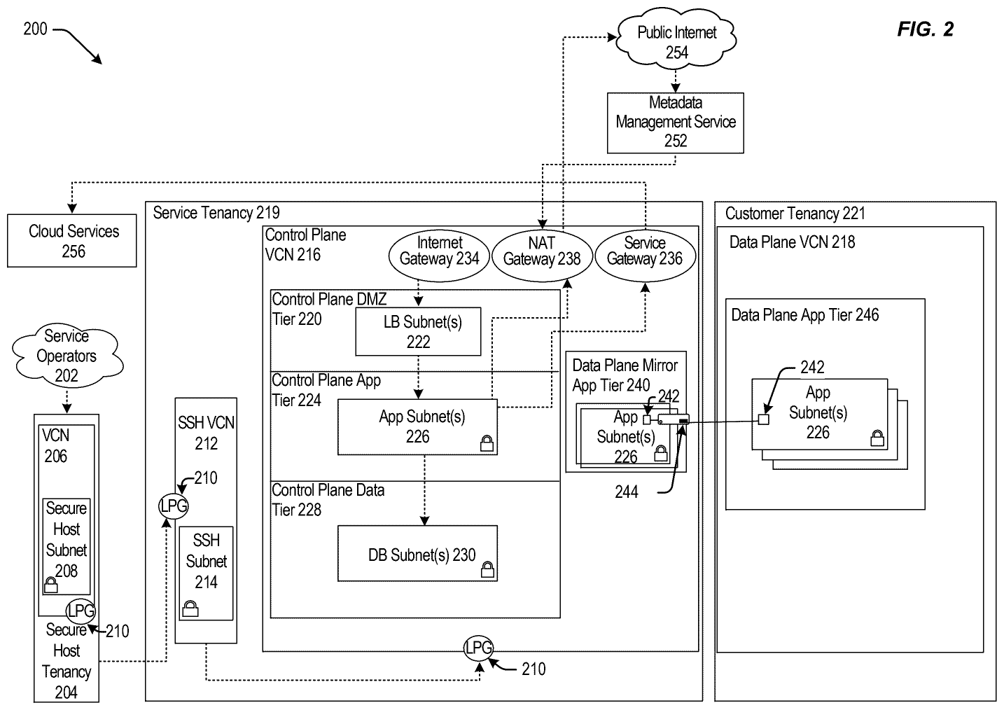

FIG. 2 is a block diagram illustrating another example pattern of an IaaS architecture 200 according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), and a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216. The app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 per customer, and the IaaS provider may, for the customer, set up a unique, compute instance 244 that is contained in the service tenancy 219. Compute instance 244 may allow communication between the control plane VCN 216 contained in the service tenancy 219 and the data plane VCN 218 that is contained in the customer tenancy 221. The compute instance 244 may allow resources provisioned in the control plane VCN 216 that is contained in the service tenancy 219 to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment or other usage of resources of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

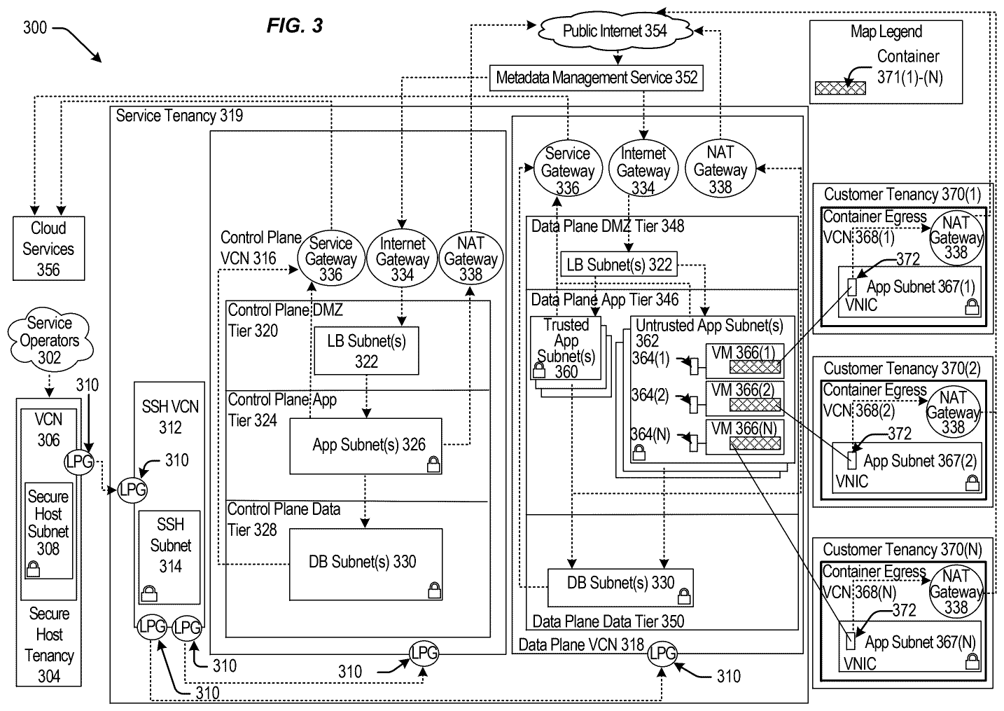

FIG. 3 is a block diagram illustrating another example pattern of an IaaS architecture 300 according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane VCN 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), and a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360, untrusted app subnet(s) 362 of the data plane app tier 346, and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Tenant(s) VM 366(1)-(N) can be communicatively coupled to a respective app subnet 367(1)-(N) that can be contained in respective container egress VCNs 368(1)-(N) that can be contained in respective customer tenancies 380(1)-(N). Respective secondary VNICs 372(1)-(N) can facilitate communication between the untrusted app subnet(s) 362 contained in the data plane VCN 318 and the app subnet contained in the container egress VCNs 368(1)-(N). Container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management service 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 380. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether or not to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. VM 366(1)-(N) may be connected to one customer tenancy 380. Respective containers 381(1)-(N) contained in the VMs 366(1)-(N) may be configured to run the code. In this case, there can be a dual isolation (e.g., the containers 381(1)-(N) running code), where the containers 381(1)-(N) may be contained in at least the VM 366(1)-(N) that are contained in the untrusted app subnet(s) 362) that may help prevent incorrect or otherwise undesirable code from damaging the network of the IaaS provider or from damaging a network of a different customer. The containers 381(1)-(N) may be communicatively coupled to the customer tenancy 380 and may be configured to transmit or receive data from the customer tenancy 380. The containers 381(1)-(N) may not be configured to transmit or receive data from any other entity in the data plane VCN 318. Upon completion of running the code, the IaaS provider may kill or otherwise dispose of the containers 381(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 381(1)-(N) that can be contained in the VM 366(1)-(N) of the customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

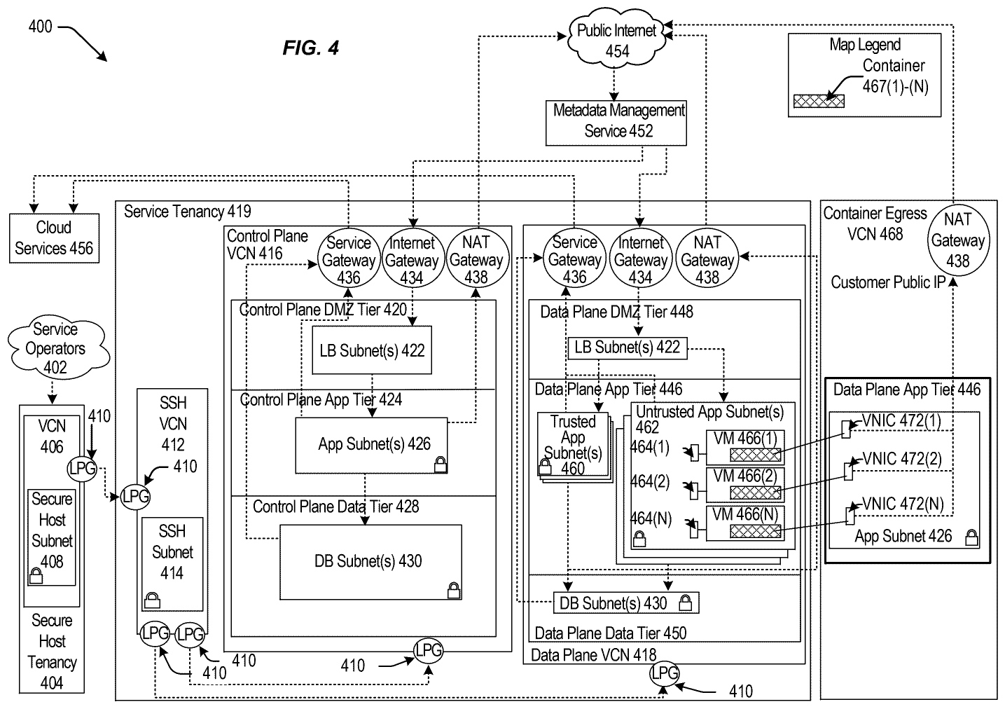

FIG. 4 is a block diagram illustrating another example pattern of an IaaS architecture 400 according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane VCN 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), and a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Tenant VM 466(1)-(N) can run code in a respective container 467(1)-(N) and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management service 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for customers can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that request a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, and 400 may include components that are different and/or additional to the components shown in the figures. Further, the embodiments shown in the figures represent non-exhaustive examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

In one or more embodiments, a computer network provides connectivity among a set of nodes. The nodes may be local to and/or remote from one other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network such as a physical network. A node in an overlay network corresponds to a respective node in the underlying network. Hence, a node in an overlay network is associated with both an overlay address (to address to the overlay node) and an underlay address (to address the underlay node that implements the overlay node). An overlay node may be a digital device and/or a software process, such as a virtual machine, an application instance, or a thread. A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of one another. Network resources are dynamically assigned to the requests and/or clients on an on-demand basis. Network resources assigned to a request and/or client may be scaled up or down based on one or more of the following: (a) the computing services requested by a particular client, (b) the aggregated computing services requested by a particular tenant, or (c) the aggregated computing services requested of the computer network. Such a computer network may be referred to as a “cloud network.”

In an embodiment, a service provider provides a cloud network to one or more end users. Various service models may be implemented by the cloud network, including, but not limited, to Software-as-a-Service (SaaS), Platform-as-a-Service (PaaS), and Infrastructure-as-a-Service (IaaS). In SaaS, a service provider provides end users the capability to use the service provider's applications that are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities; the term “entity” as used herein refers to a corporation, organization, person, or other entity. The network resources may be local to and/or remote from the premises of the particular group of entities. In a public cloud, cloud resources are provisioned for multiple entities that are independent from one another (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on one other. A call from an application at the private cloud to an application at the public cloud (and vice versa) may be executed through the interface.

In an embodiment, tenants of a multi-tenant computer network are independent of one another. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with other tenants. Various tenant isolation approaches may be used.

In an embodiment, a tenant is associated with a tenant ID. The network resource of the multi-tenant computer network is tagged with a tenant ID. A tenant is permitted access to a particular network resource when the tenant and the particular network resources are associated with a same tenant ID.

In an embodiment, a tenant is associated with a tenant ID. An application, implemented by the computer network, is tagged with a tenant ID. Additionally, or alternatively, data structures and/or datasets, stored by the computer network, are tagged with a tenant ID. A tenant is permitted access to a particular application, data structure, and/or dataset when the tenant and the particular application, data structure, and/or dataset are associated with a same tenant ID.

As an example, a database implemented by a multi-tenant computer network may be tagged with a tenant ID. A tenant associated with the corresponding tenant ID may access data of a particular database. As another example, an entry in a database implemented by a multi-tenant computer network may be tagged with a tenant ID. A tenant associated with the corresponding tenant ID may access data of a particular entry. However, multiple tenants may share the database.

In an embodiment, a subscription list identifies a set of tenants, and, for a particular tenant, a set of applications that the particular tenant is authorized to access. For a particular application, a list of tenant IDs of tenants authorized to access the particular application is stored. A tenant is permitted access to a particular application when the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 5. Computer System

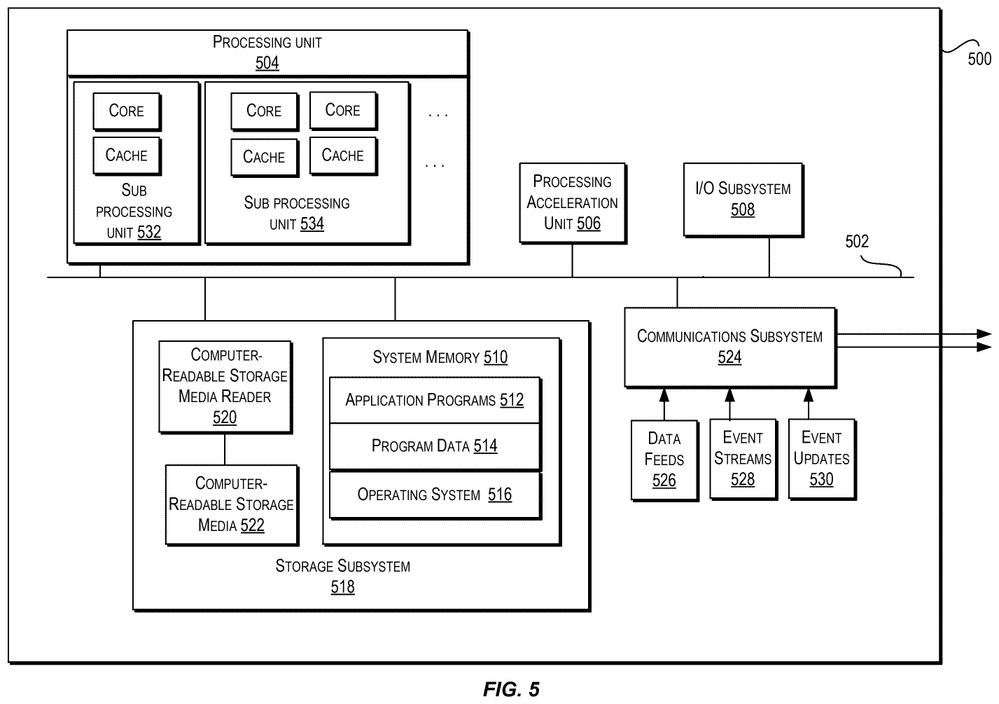

FIG. 5 illustrates an example computer system 500. An embodiment of the disclosure may be implemented upon the computer system 500. As shown in FIG. 5, computer system 500 includes a processing unit 504 that communicates with peripheral subsystems via a bus subsystem 502. These peripheral subsystems may include a processing acceleration unit 506, an I/O subsystem 508, a storage subsystem 518, and a communications subsystem 524. Storage subsystem 518 includes tangible computer-readable storage media 522 and a system memory 510.

Bus subsystem 502 provides a mechanism for letting the various components and subsystems of computer system 500 to communicate with one another as intended. Although bus subsystem 502 is shown schematically as a single bus, alternative embodiments of the bus subsystem may utilize multiple buses. Bus subsystem 502 may be any of several types of bus structures, including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Additionally, such architectures may be implemented as a Mezzanine bus manufactured to the IEEE P1386.1 standard.

Processing unit 504 controls the operation of computer system 500. Processing unit 504 can be implemented as one or more integrated circuits (e.g., a conventional microprocessor or microcontroller). One or more processors may be included in processing unit 504. These processors may include single core or multicore processors. In certain embodiments, processing unit 504 may be implemented as one or more independent processing units 532 and/or 534 with single or multicore processors included in the processing unit. In other embodiments, processing unit 504 may also be implemented as a quad-core processing unit formed by integrating two dual-core processors into a single chip.

In various embodiments, processing unit 504 can execute a variety of programs in response to program code and can maintain multiple concurrently executing programs or processes. At any given time, the program code to be executed can be wholly or partially resident in processing unit 504 and/or in storage subsystem 518. Through suitable programming, processing unit 504 can provide various functionalities described above. Computer system 500 may additionally include a processing acceleration unit 506 that can include a digital signal processor (DSP), a special-purpose processor, and/or the like.

I/O subsystem 508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include medical imaging input devices such as computed tomography, magnetic resonance imaging, position emission tomography, or medical ultrasonography devices. User interface input devices may also include audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include any type of device and mechanism for outputting information from computer system 500 to a user or other computer. For example, user interface output devices may include, without limitation, a variety of display devices that visually convey text, graphics and audio/video information, such as monitors, printers, speakers, headphones, automotive navigation systems, plotters, voice output devices, and modems.

Computer system 500 may comprise a storage subsystem 518 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 504 provide the functionality described above. Storage subsystem 518 may also provide a repository for storing data used in accordance with the present disclosure.

As depicted in the example in FIG. 5, storage subsystem 518 can include various components, including a system memory 510, computer-readable storage media 522, and a computer readable storage media reader 520. System memory 510 may store program instructions, such as application programs 512, that are loadable and executable by processing unit 504. System memory 510 may also store data, such as program data 514, that is used during the execution of the instructions and/or data that is generated during the execution of the program instructions. Various programs may be loaded into system memory 510 including, but not limited to, client applications, Web browsers, mid-tier applications, relational database management systems (RDBMS), virtual machines, containers, etc.

System memory 510 may also store an operating system 516. Examples of operating system 516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 500 executes one or more virtual machines, the virtual machines along with their guest operating systems (GOSs) may be loaded into system memory 510 and executed by one or more processors or cores of processing unit 504.

System memory 510 can come in different configurations depending upon the type of computer system 500. For example, system memory 510 may be volatile memory (such as random access memory (RAM)) and/or non-volatile memory (such as read-only memory (ROM), flash memory, etc.). Different types of RAM configurations may be provided, including a static random access memory (SRAM), a dynamic random access memory (DRAM), and others. In some implementations, system memory 510 may include a basic input/output system (BIOS) containing basic routines that help to transfer information between elements within computer system 500 such as during start-up.

Computer-readable storage media 522 may represent remote, local, fixed, and/or removable storage devices plus storage media for temporarily and/or more permanently containing, storing, computer-readable information for use by computer system 500, including instructions executable by processing unit 504 of computer system 500.

Computer-readable storage media 522 can include any appropriate media known or used in the art, including storage media and communication media, such as but not limited to volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 522 may include, but is not limited to, Zip® drives, flash memory cards, universal serial bus (USB) flash drives, secure digital (SD) cards, DVD disks, digital video tape, and the like. Computer-readable storage media 522 may also include solid-state drives (SSD) based on non-volatile memory, such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 500.

Machine-readable instructions executable by one or more processors or cores of processing unit 504 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 524 provides an interface to other computer systems and networks. Communications subsystem 524 serves as an interface for receiving data from and transmitting data to other systems from computer system 500. For example, communications subsystem 524 may enable computer system 500 to connect to one or more devices via the Internet. In some embodiments, communications subsystem 524 can include radio frequency (RF) transceiver components to access wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments, communications subsystem 524 can provide wired network connectivity (e.g., Ethernet) in addition to or instead of a wireless interface.

In some embodiments, communications subsystem 524 may also receive input communication in the form of structured and/or unstructured data feeds 526, event streams 528, event updates 530, and the like on behalf of one or more users who may use computer system 500.

By way of example, communications subsystem 524 may be configured to receive data feeds 526 in real-time from users of social networks and/or other communication services, such as Twitter® feeds, Facebook® updates, web feeds such as Rich Site Summary (RSS) feeds, and/or real-time updates from one or more third party information sources.

Additionally, communications subsystem 524 may be configured to receive data in the form of continuous data streams. The continuous data streams may include event streams 528 of real-time events and/or event updates 530 that may be continuous or unbounded in nature with no explicit end. Examples of applications that generate continuous data may include sensor data applications, financial tickers, network performance measuring tools (e.g., network monitoring and traffic management applications), clickstream analysis tools, automobile traffic monitoring, and the like.

Communications subsystem 524 may also be configured to output the structured and/or unstructured data feeds 526, event streams 528, event updates 530, and the like to one or more databases that may be in communication with one or more streaming data source computers coupled to computer system 500.

Computer system 500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 500 depicted in FIG. 5 is intended as a non-limiting example. Many other configurations having more or fewer components than the system depicted in FIG. 5 are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

### 6. Architectural Overview

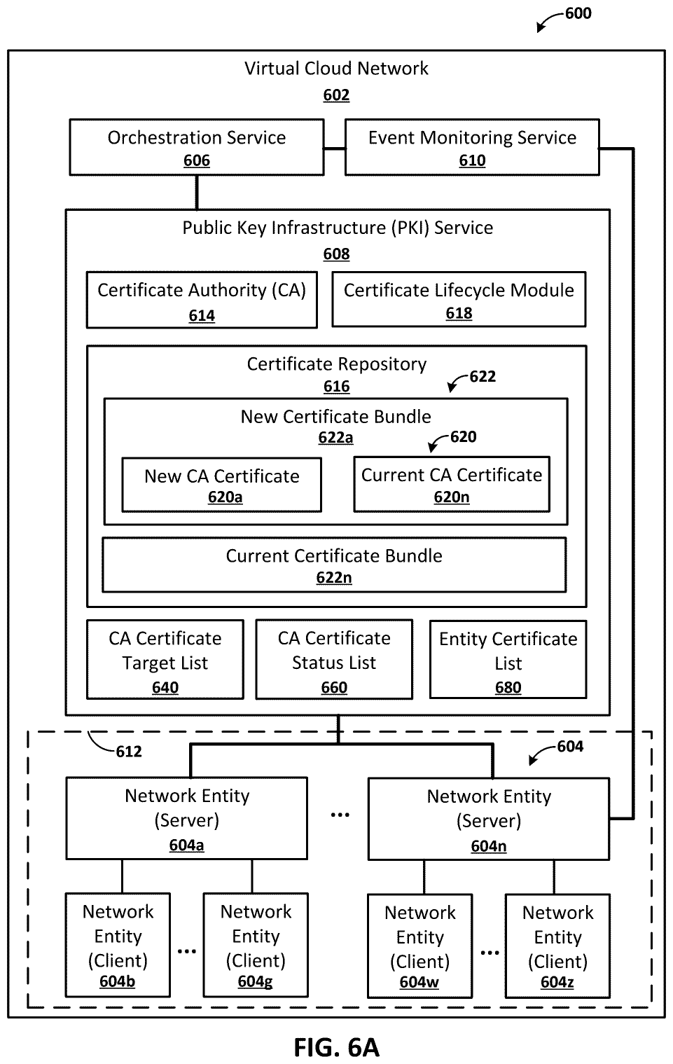

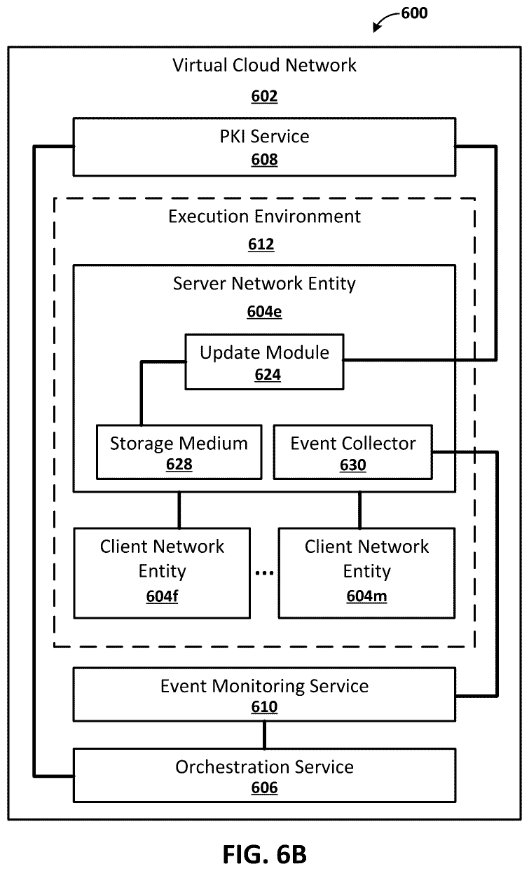

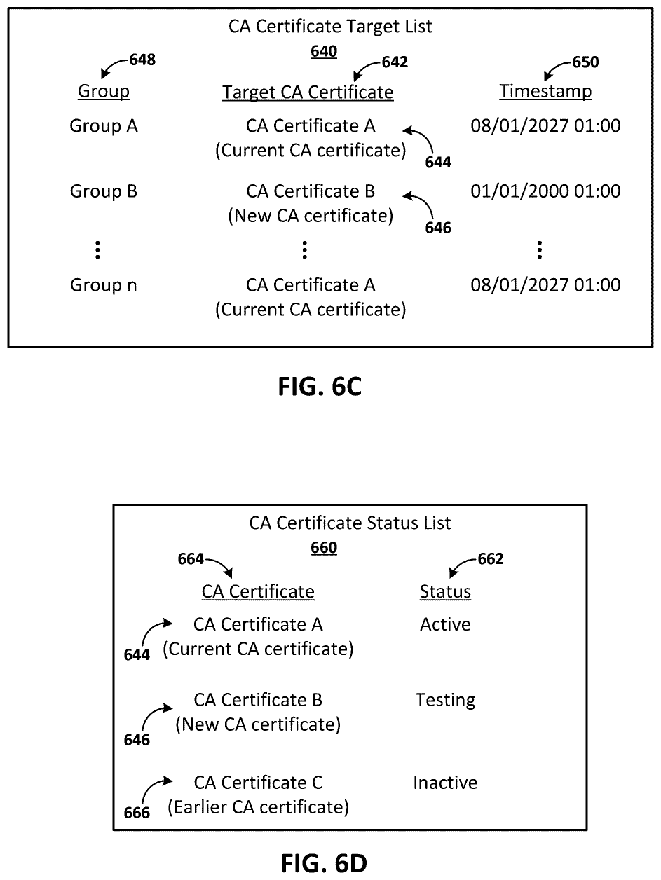

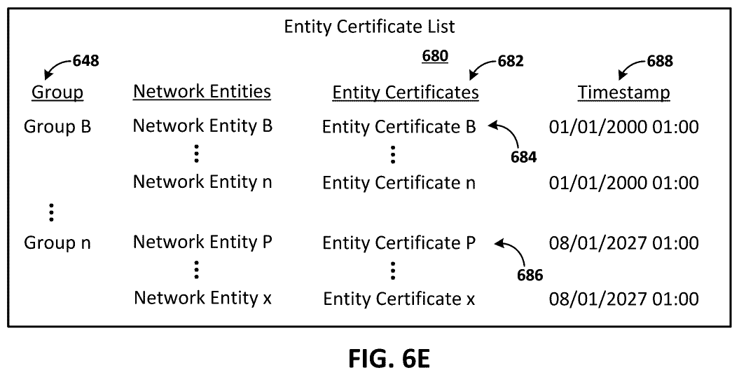

FIGS. 6A-6E illustrate features of an example system 600 in accordance with one or more embodiments. The system 600 described with reference to FIGS. 6A-6E may perform operations pertaining to distribution processes for distributing artifacts to an execution environment of a computing network. As used herein, the term “artifact” refers to any deployable unit or package that contains code, configuration files, libraries, and other resources that may be utilized to perform operations or to run an application or service. An artifact may include code, scripts, binaries, or container images that are deployable to computing resources such as virtual machines, containers, or serverless platforms. Example artifacts include certificate bundles (e.g., containing CA certificates), digital certificates, compiled executable files, docker images (e.g., containing application code, dependencies, and/or runtime environment settings), virtual machine images (e.g., containing pre-installed software stacks), or configuration files.

In one example, as described with reference to FIGS. 6A-6E, the system 600 may perform operations pertaining to distribution processes for distributing digital certificates to an execution environment of a computing network. A distribution process may include issuing CA certificates, generating certificate bundles that included the CA certificates, and distributing the certificate bundles to the execution environment. The certificate bundles may be utilized in an authentication protocol for authenticating network entities in the execution environment based on entity certificates issued based on a CA certificate in a certificate bundle. Additionally, or alternatively, a distribution process may include issuing entity certificates to network entities and distributing the entity certificates to the network entities for authentication in the authentication protocol. Additionally, or alternatively, the system 600 described with reference to FIGS. 6A-6E may perform operations pertaining to orchestrating testing processes for performing testing operations pertaining to testing digital certificates in an execution environment of a computing network. A testing process may be executed in connection with the distribution of digital certificates to the execution environment. In one example, one or more testing processes may be executed during, prior to, and/or between one or more phases of a certificate distribution process.

### A. Example Computing Network

As shown in FIG. 6A, the system 600 includes a computing network such as a virtual cloud network 602. The virtual cloud network 602 includes a plurality of network entities 604 (such as network entity 604a, network entity 604b, network entity 604g, network entity 604n, network entity 604w, and network entity 604z). In one example, network entity 604a is a server network entity, and network entity 604b and network entity 604g are client network entities serviced by network entity 604a. Additionally, or alternatively, network entity 604n is a server network entity, and network entity 604w and network entity 604z are client network entities serviced by network entity 604n.

The virtual cloud network 602 further includes an orchestration service 606, a public key infrastructure (PKI) service 608, and an event monitoring service 610. The orchestration service 606 orchestrates certificate distribution processes and testing processes. The orchestration service may orchestrate a certificate distribution process according to an automated process and/or in response to operator inputs. The PKI service 608 generates and distributes digital certificates to the network entities 604. The event monitoring service 610 monitors events associated with the virtual cloud network 602 such as events associated with the network entities 604. The orchestration service 606 interacts with the event monitoring service 610 and/or directly with the network entities 604 to obtain information that the orchestration service 606 utilizes to orchestrate certificate distribution processes and/or testing processes.

The virtual cloud network 602 further includes at least one execution environment 612. The execution environment 612 includes network entities 604 and other portions of the virtual cloud network 602 that deploy and/or run network services, resources, and/or infrastructure. As shown in FIG. 6A, the execution environment 612 includes server network entities, such as network entity 604a and network entity 604n, and client network entities, such as network entity 604b, network entity 604g, network entity 604w, and network entity 604z. In one example, the execution environment additionally includes the PKI service 608, the orchestration service 606, and/or the event monitoring service 610. The orchestration service 606 may orchestrate testing processes that are executed within the execution environment 612.

Referring further to FIG. 6A, the PKI service 608 includes a certificate authority 614, a certificate repository 616, and a certificate lifecycle module 618. The certificate authority 614 issues CA certificates 620. Additionally, the certificate authority 614 issues entity certificates based on CA certificates 620. In one example, the certificate authority 614 issues a root CA certificate. Additionally, or alternatively, the certificate authority 614 may issue a set of entity certificates from the root CA certificate. Additionally, or alternatively, the certificate authority 614 may issue one or more intermediate CA certificates from the root CA certificate. Additionally, or alternatively, the certificate authority 614 may issue one or more entity certificates from an intermediate CA certificate.

One or more CA certificates 620 issued by the certificate authority 614 are stored in the certificate repository 616. In one example, the certificate authority 614 may generate a certificate bundle 622 that includes one or more CA certificates 620. The certificate authority 614 may store one or more certificate bundles 622 in the certificate repository 616. Additionally, or alternatively, the certificate repository 616 may store entity certificates for distribution to network entities 604 in the execution environment. In one example, the certificate repository 616 may store a set of entity certificates issued based on a CA certificate 620 in a certificate bundle 622 stored in the certificate repository 616.

In one example, as shown in FIG. 6A, the certificate repository 616 includes a new certificate bundle 622a and a current certificate bundle 622n. The new certificate bundle 622a and the current certificate bundle 622n may respectively include a set of one or more CA certificates 620. The new certificate bundle 622a may include a new CA certificate 620a. In one example, the new certificate bundle 622a may additionally include a current CA certificate 620n. The current certificate bundle 622n may include the current CA certificate 620n. The new certificate bundle 622a may supersede the current certificate bundle 622n upon being installed in the execution environment 612. Additionally, or alternatively, the new CA certificate 620a may supersede the current CA certificate 620n upon being installed in the execution environment. When the new certificate bundle 622a supersedes the current certificate bundle 622n, the new certificate bundle 622a becomes the current certificate bundle 622n. In one example, a new certificate bundle 622a that includes a new CA certificate 620a and a current CA certificate 620n may supersede a current certificate bundle 622n that includes the current CA certificate 620n. Subsequently, the current CA certificate 620n included in the new certificate bundle 622a may be removed from the execution environment by distributing a new certificate bundle 622a that includes the new CA certificate 620a and that is exclusive of (does not include) the current CA certificate 620n. When the new CA certificate 620a supersedes the current CA certificate 620n, the new CA certificate 620a becomes the current CA certificate 620n.

The certificate lifecycle module 618 performs operations associated with expiration and replacement of digital certificates. The certificate lifecycle module 618 may determine that a current CA certificate 620n is approaching expiration. In response to determining that the current CA certificate 620n is approaching expiration, the certificate lifecycle module 618 may prompt the certificate authority 614 to generate a new CA certificate 620a that will supersede the current CA certificate 620n. Additionally, or alternatively, the certificate lifecycle module 618 may prompt the certificate authority 614 to generate new entity certificates from the new CA certificate 620a. The certificate authority 614 may generate new entity certificates, for example, when prompted by the certificate lifecycle module 618. In one example, the certificate lifecycle module 618 may prompt the certificate authority 614 to generate new entity certificates to replace expiring entity certificates. Additionally, or alternatively, the certificate lifecycle module 618 may prompt the certificate authority 614 to generate new entity certificate in connection with issuance of a new CA certificate 620a so that the entity certificates can be authenticated via the new CA certificate 620a.

### B. Example Network Entities

Referring to FIG. 6B, example network entities 604 of the system 600 are further described. As shown in FIG. 6B, an execution environment 612 may include a plurality of network entities 604, such as server network entity 604e, client network entity 604f, and client network entity 604m. In one example, server network entity 604e corresponds to network entity 604a, client network entity 604f corresponds to network entity 604b, and client network entity 604m corresponds to network entity 604g, respectively, as shown in FIG. 6A. As illustrated with respect to server network entity 604e, a network entity 604 may include an update module 624, a storage medium 628, and an event collector 630. The update module 624 may include an agent or application executing on the network entity 604. The update agent 624 periodically calls the PKI service 608 for a certificate bundle 622a. The update module 624 downloads the new certificate bundle 622a from the PKI service 608 and installs the certificate bundle 622 to the storage medium 628. Additionally, or alternatively, the update module 624 periodically calls the PKI service 608 for new entity certificates. The update module 624 downloads the new entity certificates from the PKI service 608 and stores the new entity certificates in storage medium 628.

In one example, the update module 624 distributes certificate bundles 622 and/or entity certificates to other network entities 604, such as client network entity 604f and/or client network entity 604m. The update module 624 of server network entity 604e may download a first entity certificate issued for server network entity 604e, a second entity certificate issued for client network entity 604f, and a third entity certificate issued for client network entity 604m. The update module 624 may store the first entity certificate in the storage medium 628 associated with the server network entity 604e for use by the server network entity 604e when authenticating against a CA certificate 620 in accordance with a security protocol. The update module 624 may transmit the second entity certificate to client network entity 604f. Client network entity 604f may store the second entity certificate in a storage medium associated with client network entity 604f and may utilize the second entity certificate when authenticating against a CA certificate 620 in accordance with a security protocol. The update module 624 may transmit the third entity certificate to client network entity 604m. Client network entity 604m may store the third entity certificate in a storage medium associated with client network entity 604m and may utilize the third entity certificate when authenticating against a CA certificate 620 in accordance with a security protocol.

An event collector 630 may collect information pertaining to events occurring with respect to a network entity 604 and transmit the information to the event monitoring service 610. The event monitoring service 610 may transmit the information received from one or more event collectors 630 to the orchestration service 606. In one example, the event collector 630 transmits test results to the event monitoring service 610, and the event monitoring service 610 transmits the test results to the orchestration service 606. In one example, the event monitoring service 610 may generate event logs based on information received from one or more event collectors 630, and the orchestration service 606 may detect events in the event logs generated by the event monitoring service 610. The events in the event logs may include, or may be indicative of, the test results. In one example, the event monitoring service 610 may transmit the event logs to the orchestration service 606.

The network entities 604 may be located throughout the virtual cloud network 602. A network entity 604 may reside on a substrate network, an overlay network, or a network interface. A network entity 604 may be implemented in hardware and/or software. The plurality of network entities 604 may include one or more substrate entities, one or more interface entities, and/or one or more overlay entities.

As used herein, the term “substrate entity” refers to a network entity 604 implemented in a substrate network. As used herein, the term “substrate network” refers to a physical network infrastructure. The substrate network provides a foundation of a virtual cloud network. The substrate network may include physical network devices, such as routers, switches, network links, and other networking components. The substrate network may provide the basic connectivity and transport capabilities necessary for data transmission within and between data centers.

The one or more substrate entities may include substrate hosts, routers, firewalls appliances, load balancers, storage devices, and/or substrate services. A substrate host may include an endpoint within the substrate network, such as a bare metal host, a virtual machine, a container, or a physical server. A substrate service may include a service executing or executable on a substrate entity, such as a firmware service, a network connectivity service, an addressing service, a name resolution service, a security service, a network monitoring service, a load balancing service, and/or a storage service. A firmware service may be associated with functionality or management of network infrastructure components or services, such as network devices, boot-up or initialization process, hardware controls, feature enablement, updates, hardware abstraction, network configuration, and/or network management. In one example, a substrate entity may include a combination of hardware and software. In one example, the one or more substrate entities may include one or more substrate hosts and/or one or more substrate services. In one example, a substrate host may include a bare metal host. In one example, a substrate service may include a firmware service. The substrate entities may communicate with one another and/or with other network entities 604 using logical network addresses assigned within the overlay network.

As used herein, the term “network interface” refers to a communication interface between a substrate network and an overlay network, such as a network interface card, a smartNIC, or the like. A network interface may include one or more interface entities, such as a node on the network interface or an interface service executing or executable on the network interface. A node on the network interface may include a programmable hardware component, a memory component, or a gateway component. In one example, a network interface may include a network interface card such as a smartNIC. Additionally, or alternatively, a network interface may include a node or an endpoint on a network interface card or smartNIC.

A gateway component may provide connectivity between the substrate network and the network interface and/or between the network interface and the overlay network. For example, a gateway component may enable communication between overlay entities and substrate entities. Additionally, or alternatively, a gateway component may provide connectivity between the overlay network and external networks, such as the internet or other networks outside the overlay network. For example, an overlay gateway may enable communication between overlay entities and external endpoints.

As used herein, the term “overlay network” refers to a virtual network built on a substrate network using software-defined networking (SDN), virtualization, tunneling, and/or encapsulation technologies. An overlay network may operate independently of the underlying substrate network. An overlay network may provide logical separation and isolation of traffic, enable virtual network provisioning, and/or allow for implementation of various network services and policies. Virtual machines, hosts, containers, or virtual network functions running on a substrate network may be connected via an overlay network.

As used herein, the term “overlay entity” refers to a network entity implemented on an overlay network. The overlay network may include a plurality of overlay entities. The plurality of overlay entities may include overlay hosts, overlay services, subnets, overlay controllers, and/or overlay clients. In one example, the overlay network may include a plurality of overlay entities. In one example, an overlay entity may include an overlay host. Additionally, or alternatively, an overlay entity may include an overlay service. The plurality of overlay entities may communicate with one another using logical network addresses assigned within the overlay network.

An overlay host may include an endpoint within the overlay network, such as a virtual machine, a container, or a physical server. An overlay service may include a service executing or executable on an overlay entity. An overlay service may include a client-specific service such as a service installed by a client. Additionally, or alternatively, an overlay service may include a virtual network creation service, a virtual network management service, a virtual machine orchestration service, a container orchestration service, a network virtualization service, an overlay security service, a load balancing service, a multi-tenancy service, and/or a tenant isolation service.

A subnet may include a virtual network segment that has a distinct addressing scheme and/or a distinct set of network policies or services. A subnet may include a set of overlay hosts. Multiple subnets may be utilized to partition respective sets of overlay hosts. An overlay controller may oversee management, control, provisioning, configuration, and/or monitoring of an overlay network, network entities on the overlay network, and/or network policies within the overlay. An overlay controller interacts with the underlying substrate network, for example, to coordinate the operation of overlay hosts and/or communications across virtual switches and tunnels. An overlay client may include an endpoint or device that initiates communication within the overlay network. An overlay client may be a specific instance or role within an overlay host. An overlay host may include a set of overlay clients. An overlay client may include a consumer or user of services provided by overlay hosts or the IaaS. An overlay client may request and consume resources or services from overlay hosts that act as consumers or clients of those resources or services.

The plurality of network entities 604 may include a plurality of data repositories. The data repositories may include any type of storage unit and/or device (e.g., a file system, database, collection of tables, or any other storage mechanism) for storing data. Further, a data repository may include multiple different storage units and/or devices. The multiple different storage units and/or devices may or may not be of the same type or located at the same physical site. The data repositories may share one or more storage units with one another. Additionally, or alternatively, the data repositories may include one or more storage units that differ from one another. Further, one or more of the data repositories may be implemented or executed on the same computing system as virtual cloud network 602. Additionally, or alternatively, one or more of the data repositories may be implemented or executed on a computing system separate from virtual cloud network 602.

### C. Example PKI Service

Referring again to FIG. 6A, the PKI service 608 may maintain one or more data structures that include information pertaining to digital certificates and/or distribution of the digital certificates to the execution environment 612. In one example, the one or more data structures may include a CA certificate target list 640. The CA certificate target list 640 may include one or more data structures that identify the CA certificate 620 to be utilized by the certificate authority 614 when generating entity certificates. An example CA certificate target list 640 is further described below with reference to FIG. 6C. Additionally, or alternatively, the one or more data structures may include a CA certificate status list 660. The CA certificate status list 660 may identify a status of one or more CA certificates, such as whether the CA certificate is active or inactive in the execution environment 612. An example CA certificate status list 660 is further described below with reference to FIG. 6D. Additionally, or alternatively, the one or more data structures may include an entity certificate list 680. The entity certificate list 680 may identify a set of network entities 604 that have been issued an entity certificate. Additionally, or alternatively, entity certificate list 680 may identify a set of network entities 604 and/or that are eligible to receive a new entity certificate. Additionally, or alternatively, the entity certificate list 680 may identify a set of entity certificates that have been distributed and/or that are available for distribution to the network entities 604 in the execution environment 612. An example entity certificate list 680 is further described below with reference to FIG. 6E.

In one example, the data structure maintained by the certificate lifecycle module 618 may include one or more epoch dates that are utilized to indicate whether one or more digital certificates are expired and/or are nearing expiration. In one example, the epoch date is a reference dates that represents an earliest start date for a digital certificate. If the epoch date for a digital certificate is a future date, the digital certificate is deemed expired. In one example, the certificate lifecycle module 618 may trigger issuance of new digital certificates based on an epoch date. In one example, the certificate lifecycle module 618 may set the epoch date to a future date, thereby triggering issuance of new digital certificates to replace digital certificates associated with the epoch date. In one example, the certificate lifecycle module 618 trigger issuance of new digital certificates associated with an epoch date when a difference between a current date and the epoch date meet a threshold. An epoch date may correspond to at least a portion of the execution environment. In one example, a first epoch date may correspond to a CA certificate 620, and a second epoch date may correspond to a set of entity certificates issued from the CA certificate 620. Additionally, or alternatively, a first epoch date may correspond to a first portion of the execution environment, and a second epoch date may correspond to a second portion of the execution environment. For example, a first epoch date may correspond to a first set of network entities 604, and a second epoch date may correspond to a second set of network entities 604.

The certificate lifecycle module 618 may update an epoch date corresponding to one or more digital certificates to trigger issuance of new digital certificates to replace the digital certificates corresponding to the updated epoch date. Additionally, or alternatively, the certificate lifecycle module 618 may update an epoch date corresponding to at least a portion of the execution environment 612 to trigger issuance of new digital certificates with respect to the portion of the execution environment 612 corresponding to the updated epoch date. In one example, the certificate lifecycle module 618 may update an epoch date corresponding to a particular set of network entities 604, such as a server network entity (e.g., network entity 604a) and a set of client network entities corresponding to the server network entity (e.g., network entity 604b and network entity 604g).

In one example, the certificate lifecycle module 618 may update an epoch date in response to a prompt from the orchestration service 606. Additionally, or alternatively, the certificate lifecycle module 618 may update an epoch date in response to an input from a user input device. Additionally, or alternatively, the certificate lifecycle module 618 may update an epoch date in response to a security concern. The issuance of new digital certificates corresponding to the updated epoch date may mitigate the security concern.

The PKI service 608 may distribute certificate bundles 622 to the execution environment 612. Additionally, or alternatively, the PKI service 608 may distribute entity certificates to the execution environment 612. The PKI service 608 may identify the certificate bundles 622 and/or the entity certificates for distribution to the execution environment based on the data structure maintained by the certificate lifecycle module 618. In one example, one or more network entities 604 may periodically prompt the PKI service 608 for a new certificate bundle 622a, for example, via an update module 624. When a new certificate bundle 622a is available for distribution, the PKI service 608 may distribute the certificate bundle 622 to the one or more network entities in response to the periodic prompts. Additionally, or alternatively, one or more network entities may periodically prompt the PKI service 608 for new entity certificates. When new entity certificates are available for distribution, for example, when current entity certificates are approaching expiration, the PKI service 608 may distribute the new entity certificates to the one or more network entities in response to the periodic prompts. Additionally, or alternatively, the PKI service 608 may periodically check the data structure for new certificate bundles 622a and/or new entity certificates that are available for distribution and may distribute the new certificate bundles 622a and/or new entity certificates to the corresponding network entities 604. Additionally, or alternatively, the PKI service 608 may distribute certificate bundles 622 and/or entity certificates in response to a prompt from the orchestration service 606. In one example, the orchestration service 606 prompts the PKI service 608 to update an epoch date to trigger issuance and/or distribution of new digital certificates.

The orchestration service 606 may perform validations to validate testing processes orchestrated by the orchestration service 606. The validations performed by the orchestration service 606 may be performed according to an automated process and/or in response to operator inputs via an interface of the orchestration service 606. The validations performed by the orchestration service 606 may correspond to one or more testing operations of a testing process. Additionally, or alternatively, the validations may correspond to the testing process as a whole. Additionally, or alternatively, the orchestration service 606 may receive information pertaining to testing processes from the event monitoring service 610. In one example, the orchestration service 606 may determine whether a testing process and/or a testing operation is successful. The orchestration service 606 may advance to a next stage of a testing process and/or a certificate distribution process in response to a determination that one or more testing operations are successful.

### D. Example CA Certificate Target List

Referring to FIG. 6C, an example CA certificate target list 640 is further described. As shown in FIG. 6C, a CA certificate target list 640 may identify one or more target CA certificates 642 that are to be utilized for issuing entity certificates. The target CA certificates 642 may include root CA certificates to be utilized for issuing intermediate CA certificate and/or entity certificates. Additionally, or alternatively, the target CA certificates 642 may include intermediate CA certificates to be utilized for issuing entity certificates. In one example, a target CA certificate 642 may include a current CA certificate 644 that is active in the execution environment. Additionally, or alternatively, a target CA certificate 642 may include a new CA certificate 646. The new CA certificate 646 may be active in at least a portion of the execution environment. In one example, the new CA certificate 646 may be utilized for testing in at least a portion of the execution environment. Additionally, or alternatively, the new CA certificate 646 may be inactive in at least a portion of the execution environment.

A target CA certificate 642 may be associated with a set of one or more network entities. As shown in FIG. 6C, one or more network entities may be assigned to a group 648 associated with a target CA certificate 642. In one example, the network entities may be grouped such that network entities associated with a particular group 948 receive entity certificates issued based on the target CA certificate 642 corresponding to the particular group 648. A group 648 may correspond to one or more of the following: a server network entity and corresponding client network entities, a network entity type, a service type, or a network address or address range.

In one example, as shown in FIG. 6C, network entities associated with a first group corresponding to Group A are issued entity certificates from the current CA certificate 644, and network entities associated with a second group corresponding to Group B are issued entity certificates from the new CA certificate 646. A server network entity corresponding to Group A may be issued an entity certificate and/or an intermediate CA certificate based on the current CA certificate 644. Additionally, or alternatively, a client network entity corresponding to Group A may be issued an entity certificate based on the current CA certificate 644. Additionally, or alternatively, the first group corresponding to Group A may have already been issued entity certificates from the current CA certificate 644 and may continue utilizing those entity certificates. Additionally, or alternatively, a server network entity corresponding to Group B may be issued an entity certificate and/or an intermediate CA certificate based on the new CA certificate 646. Additionally, or alternatively, a client network entity corresponding to Group B may be issued an entity certificate based on the new CA certificate 646.

In one example, a timestamp 650 is associated with a target CA certificate 642. The timestamp 650 may represent an epoch date that the PKI service utilizes to determine whether network entities in the group 648 corresponding to the target CA certificate 642 are eligible to be issued entity certificates from the target CA certificate 642. The PKI service may activate a target CA certificate 642 in the execution environment by updating the timestamp corresponding to the group 648, thereby rendering the network entities in the group 648 eligible for new entity certificates. In one example, the PKI service may activate the new CA certificate 646 in the execution environment by setting the timestamp 650 corresponding to the new CA certificate 646 to a date that renders the new CA certificate 646 eligible for issuing entity certificates to network entities in the corresponding group 648. In one example, as shown in FIG. 6C, an epoch date that is in the future may render the new CA certificate 646 eligible for issuing entity certificates. Additionally, or alternatively, as shown with respect to the group 648 corresponding to Group n, the PKI service may trigger issuance of new entity certificates from the current CA certificate by updating the timestamp associated with the group 648 corresponding to Group n. In one example, as shown in FIG. 6C, an epoch date in the future may trigger issuance of new entity certificates from the current CA certificate.

### E. Example CA Certificate Status List

Referring to FIG. 6D, an example CA certificate status list 660 is further described. A CA certificate status list 660 may indicate a status 662 of one or more CA certificates 664 in the execution environment. As shown in FIG. 6D, a status 662 corresponding to the current CA certificate 644 may indicate that the current CA certificate 644 is active in the execution environment. The current CA certificate 644 may be active in the execution environment when entity certificates issued based on the current CA certificate 644 are being authenticated in accordance with a security protocol. Additionally, or alternatively, a status 662 corresponding to the new CA certificate 646 may indicate that the new CA certificate 646 is being utilized for testing in at least a portion of the execution environment. The current CA certificate 644 may be at least partially active in the execution environment when the orchestration service is orchestrating a testing process for performing testing operations pertaining to the new CA certificate 646 in the execution environment. The testing operations may include entity certificates issued based on the new CA certificate 646 being authenticated in accordance with the security protocol. As further shown in FIG. 6D, a status 662 corresponding to an earlier CA certificate 666 may indicate that the earlier CA certificate 666 is inactive in the execution environment. The earlier CA certificate 666 may be inactive in the execution environment when the earlier CA certificate 666 is no longer being utilized to authenticate entity certificates and/or when the earlier CA certificate 666 has been removed from the execution environment.

In one example, the status 662 may be updated by the orchestration service. For example, the orchestration service may change the status 662 of the new CA certificate 646 from inactive to testing when commencing the testing process for performing testing operations pertaining to the new CA certificate 646 in the execution environment. In one example, a change in the status 662 of the new CA certificate 646 from inactive to testing may trigger an update to the timestamp 650 (FIG. 6C), and the update to the timestamp 650 may render the new CA certificate 646 eligible for issuing entity certificates to network entities in the corresponding group 648 (FIG. 6C). In one example, the orchestration service may change the status 662 of the new CA certificate 646 from testing to inactive, for example, when the testing process is complete and/or when there is an error associated with one or more of the testing operations pertaining to the new CA certificate 646. In one example, a change in the status 662 of the new CA certificate 646 from testing to inactive may trigger an update to the timestamp 650 (FIG. 6C), and the update to the timestamp 650 may trigger issuance of entity certificates, based on the current CA certificate 644, to network entities in the corresponding group 648 (FIG. 6C). Additionally, or alternatively, the orchestration service may change the status 662 of the current CA certificate 644 from active to inactive, for example, when the current CA certificate is no longer active in the execution environment and/or when the network entities in the execution environment are issued entity certificates based on to the new CA certificate 646. The orchestration service may change the status 622 of the current CA certificate from active to inactive in connection with a change to the new CA certificate from testing to active. In one example, a change in the status 662 of the current CA certificate 644 from active to inactive may trigger an update to the timestamp 650 (FIG. 6C), and the update to the timestamp 650 may trigger issuance of entity certificates, based on the new CA certificate 644, to network entities in the corresponding group 648 (FIG. 6C). In one example, a change in the status 662 of the new CA certificate 646 from testing to active. Following the change in status 662 from testing to active, network entities may continue utilizing entity certificates issued based on the new CA certificate 646, and/or the change in status 662 may trigger issuance of new entity certificates, based on the new CA certificate 644, to network entities in the corresponding group 648 (FIG. 6C).

### F. Example Entity Certificate List

Referring to FIG. 6E, an example entity certificate list 680 is further described. As shown in FIG. 6E, the entity certificate list 680 includes a set of entity certificates 682, such as entity certificates, that the PKI service has issued for network entities in the execution environment. As shown, the PKI service has issued a first set of entity certificates 684 to network entities associated with the group 648 corresponding to Group B, and a second set of entity certificates 686 to network entities associated with the group 648 corresponding to Group n. In one example, a timestamp 688 may be associated with the entity certificates 682 in the entity certificate list 680. The timestamp 688 corresponding to an entity certificate 682 may indicate whether the entity certificate 682 is eligible to be renewed. When an entity certificate 682 is eligible to be renewed, the PKI service may utilize the target CA certificate 642 (FIG. 6C) to issue a new entity certificate. The PKI service may determine the target CA certificate 642 from the CA certificate target list 640. The orchestration service may update the timestamp 688 corresponding to one or more entity certificates 682 to place the entity certificates 682 in a condition for renewal. In one example, the orchestration service may update the timestamp 688 when commencing the testing process for performing testing operations pertaining to the new CA certificate 646 in the execution environment. The timestamp 688 may be updated for entity certificates associated with a group 648 that includes network entities being utilized in the testing process. The orchestration service may update the timestamp 688 in connection with an update to the status 662 of a CA certificate 664, such as the new CA certificate 646, on the CA certificate status list 660 (FIG. 6D). In one example, the timestamp 688 may be updated at least in part responsive to the update to the status 662 of the CA certificate 664 on the CA certificate status list 660 (FIG. 6D). The update to the timestamp 688 may cause the PKI service to issue new entity certificates to the network entities being utilized in the testing process. In one example, the orchestration service may update status 662 of the new CA certificate 646 to testing (FIG. 6D), and the update may trigger an update to the timestamp 688 of the entity certificates 682 (FIG. 6E) for the network entities associated with the group 648 being utilized in the testing process. The group 648 corresponding to the new CA certificate 646 being utilized in the testing process may be determined from the CA certificate target list 640 (FIG. 6C).

Referring again to FIG. 6B together with FIG. 6E, in one example, an update module 624 executing on a server network entity 604e may periodically transmit a request to the PKI service 608 for the PKI service 608 to provide information corresponding to the entity certificates 682 issued for network entities associated with the server network entity 604e. In response to a request from the update agent 624, the PKI service 608 may transmit at least a portion of the entity certificate list 680 to the update agent 624. In one example, the PKI service 608 may transmit the portion of the entity certificate list 680 to the update agent 624 corresponding to the network entities associated with the server network entity 604e. The information transmitted to the update agent 624 from the entity certificate list 680 may include, for a particular network entity 604, information pertaining to one or more of the following: the network entity, the entity certificate, or the timestamp. The update agent 624 may determine, based on the timestamp 688 corresponding to an entity certificate 682, that the entity certificate 682 is eligible for renewal. When the update agent 624 determines that an entity certificate 682 is eligible for renewal, the update agent 624 may transmit a request to the PKI service 608 for the PKI service 608 to issue a new entity certificate. In one example, the update agent 624 may transmit a request for the PKI service 608 to issue new entity certificates to replace the first set of entity certificates 684 associated with the group 648 of network entities corresponding to Group B being utilized in the testing process.

In one or more embodiments, the system 600 may include more or fewer components than the components illustrated in FIGS. 6A-6E. The components illustrated in FIGS. 6A-6E may be local to or remote from one another. The components illustrated in FIGS. 6A-6E may include software and/or hardware components. Components may be distributed over multiple applications and/or machines. Multiple components may be combined into one application and/or machine. Operations described with respect to one component may instead be performed by another component. Additional embodiments and/or examples relating to the system 600 are described above in Section 2, titled “Cloud Computing Technology”.

In an embodiment, the system 600 may include various components implemented on one or more digital devices. The term “digital device” refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 7. Example Certificate Distribution Processes

### A. Example Certificate Distribution Process

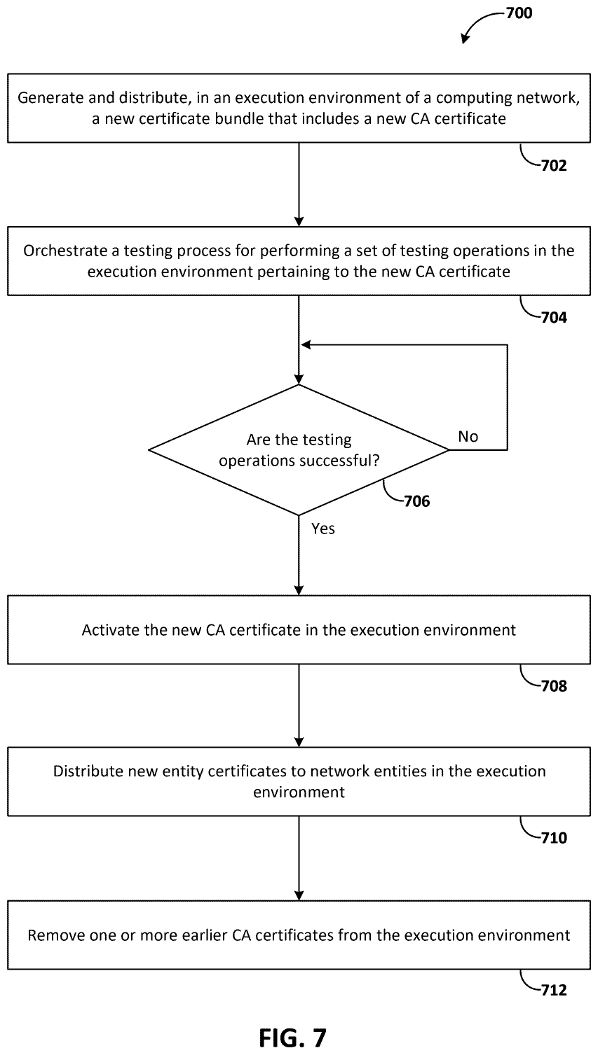

Referring now to FIG. 7, operations pertaining to an example certificate distribution process are further described. The operations 700 described with reference to FIG. 7 may be associated with distributing a new set of one or more CA certificates to a plurality of network entities for use in a certificate authentication process. The CA certificates may include root CA certificates and/or intermediate CA certificates. The CA certificates may be housed in a certificate bundle. One or more operations 700 illustrated in FIG. 7 may be modified, rearranged, or omitted. Accordingly, the particular sequence of operations 700 illustrated in FIG. 7 should not be construed as limiting the scope of one or more embodiments.

In one example, the certificate distribution process may be orchestrated by an orchestration service. In one example, the certificate distribution process may be executed in response to a trigger condition. The trigger condition may be determined based on at least one of the following: an expiry date of a certificate bundle and/or a CA certificate, a security alert, or an operator input. The trigger condition may be detected by the orchestration service.

As shown in FIG. 7, the operations 700 include generating and distributing, in an execution environment of a computing network, a new certificate bundle that includes a new CA certificates (operation 702). The new certificate bundle may be distributed to a set of network entities associated with a virtual cloud network. The new certificate bundle may include one or more new CA certificates. In one example, the new certificate bundle may also include one or more current CA certificates.

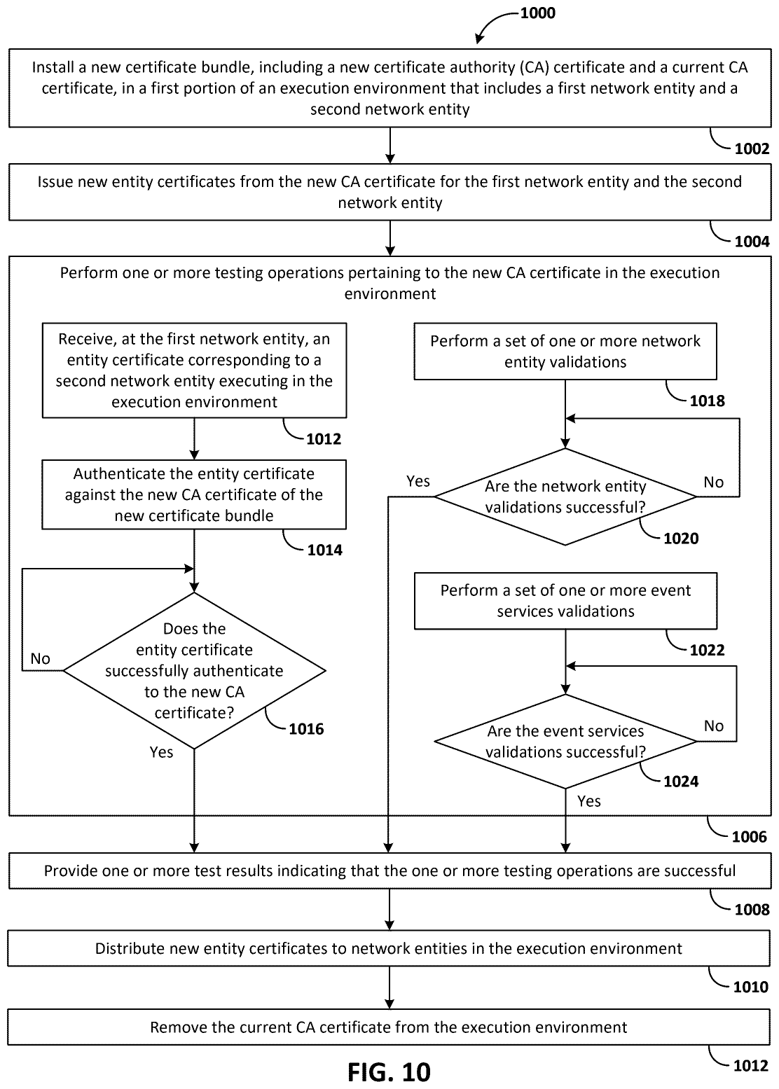

The operations 700 further include orchestrating a testing process for performing a set of testing operations in the execution environment pertaining to the new CA certificate (operation 704). The testing process may include one or more testing operations described herein such as one or more operations described with reference to FIG. 10. The operations 700 further include determining whether the testing operations are successful (operation 706). When the testing operations are successful, the operations 700 may proceed with activating the new CA certificate in the execution environment (operation 708).

In one example, activating the new CA certificate may include the PKI service issuing one or more entity certificates. The new CA certificate may be activated in at least a portion of the execution environment. In one example, the new CA certificate may be sequentially activated in a plurality of portions of the execution environment, for example, after orchestrating the testing process in respective portions of the execution environment.

The orchestration service may activate the new CA certificate by designating the new CA certificate as a target CA certificate for issuing new entity certificates in the portion of the execution environment where the new CA certificate is being activated. The orchestration service may designate the new CA certificate as the target CA certificate for issuing new entity certificates, and the orchestration service may update a data structure to indicate that the new CA certificate is designated as the target CA certificate. In one example, the orchestration service may update an epoch date corresponding to the new CA certificate and/or to the portion of the execution environment where the CA certificate is being activated. The new CA certificate may be designated as the target CA certificate with respect to the portion of the execution environment where the new CA certificate is being activated. In one example, the new CA certificate is designated as the target CA certificate with respect to a server network entity and a set of client network entities serviced by the server network entity. The designation of the new CA certificate as the target CA certificate may activate the CA certificate in at least a portion of the execution environment.

In one example, the operations 700 include distributing new entity certificates to the set of network entities in the execution environment (operation 710), for example, in the portion of the execution environment where the new CA certificate is activated. The PKI service may issue the new entity certificates based on the new CA certificate and transmit the new entity certificates to the network entities in the execution environment. In one example, the operations 700 include determining whether the new entity certificates have been successfully distributed.

In one example, the operations 700 include removing one or more earlier CA certificates from the execution environment (operation 712). The one or more earlier CA certificates may include a current CA certificate that is being superseded by a new CA certificate. In one example, removing an earlier CA certificate may include replacing a first new certificate bundle with a second new certificate bundle. The first new certificate bundle includes the new CA certificates and the earlier CA certificates, and the second new certificate bundle includes the new CA certificates and does not include the earlier CA certificates, effectively removing the earlier CA certificates from the first new certificate bundle. The second new certificate bundle may be distributed and installed in the execution environment, and the first new certificate bundle may be deleted from the execution environment.

### B. Distributing Entity Certificates to Network Entities in an Execution Environment

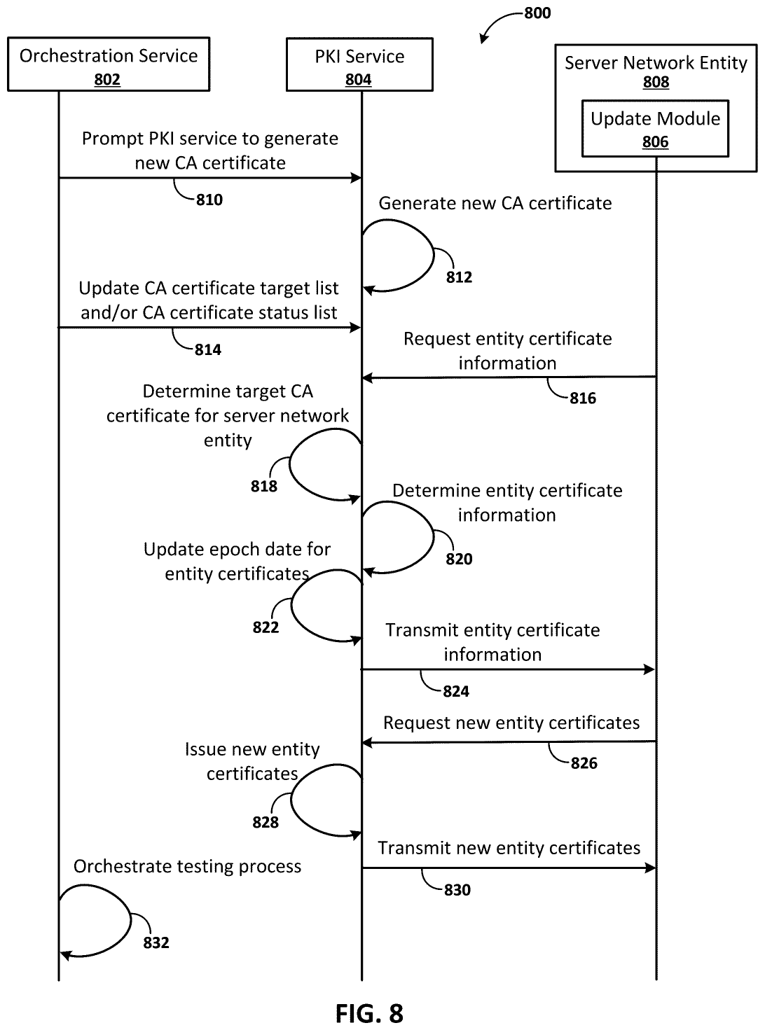

Referring to FIG. 8, example operations 800 pertaining to distributing entity certificates to network entities in an execution environment of a computing network are further described. One or more operations 800 described with reference to FIG. 8 may be modified, combined, rearranged, or omitted. Accordingly, the particular sequence of operations 800 described with reference to FIG. 8 should not be construed as limiting the scope of one or more embodiments. In one example, the operations described with reference to FIG. 8 may include one or more operations described with reference to FIG. 7. As shown in FIG. 8, the operations 800 may include operations performed by and/or associated with one or more of the following: an orchestration service 802, a PKI service 804, or an update module 806 executing on a network entity such as a server network entity 808. In one example, the operations 800 may be performed utilizing one or more components of the system 600 described with reference to FIGS. 6A-6E.

As shown in FIG. 8, the operations 800 include prompting the PKI service 804 to generate a new CA certificate (operation 810). The prompt to generate the new CA certificate may be provided to the PKI service 804 by the orchestration service 802. The PKI service 804 may generate the new CA certificate, for example, in response to the prompt from the orchestration service (operation 812).

In one example, the operations 800 include updating the CA certificate target list 640 (FIG. 6C) and/or updating the CA certificate status list 660 (FIG. 6D) (operation 814). The orchestration service 802 may execute the update. In one example, operations 800 include updating the CA certificate status list 660 to indicate that the new CA certificate is being utilized for testing in at least a portion of the execution environment. Additionally, or alternatively, the operations 800 may include updating the CA certificate target list 640 to indicate that the new CA certificate is the target CA certificate for issuing entity certificates associated with the server network entity 808.

The update module 806 may request entity certificate information from the PKI service 804 (operation 816). In response to the request for entity certificate information, the PKI service 804 may determine the target CA certificate for the server network entity (operation 818). The target CA certificate may be determined from the CA certificate target list 640 (FIG. 6C). In one example, the target CA certificate is the new CA certificate generated at operation 812. Additionally, the operations 800 may include determining entity certificate information for a set of entity certificates associated with the server network entity 808 (operation 820). The PKI service 804 may determine the entity certificate information from an entity certificate list 680 (FIG. 6E). The set of entity certificates associated with the server network entity 808 may include an entity certificate issued for the server network entity 808. Additionally, or alternatively, the set of entity certificates may include one or more entity certificates issued for one or more client network entities serviced by the server network entity 808. Additionally, or alternatively, the set of entity certificates may include one or more entity certificates issued for one or more services executing on the server network entity 808 or on a client network entity serviced by the server network entity 808. The set of entity certificates may be determined by the PKI service 804.

In one example, the operations 800 include updating an epoch date for the entity certificates associated with the server network entity (operation 822). In one example, the update to the epoch date may be triggered in response to determining that the new CA certificate is the target CA certificate for the entity certificates associated with the server network entity. The update to the epoch date may place the entity certificates associated with the server network entity 808 in a condition for renewal. The operations 800 further include transmitting the entity certificate information to the update agent 806 associated with the server network entity 808 (operation 824). The entity certificate information may include one or more of the following: a list of entity certificates associated with the server network entity 808, network entities that the entity certificates were issued for, and a timestamp corresponding to the entity certificates. The timestamp corresponding to the entity certificates may indicate that the entity certificates are eligible for renewal.

In response to the entity certificate information, the update agent 806 may request new entity certificates (operation 826). The new entity certificates may be requested for the network entities that have an entity certificate that is eligible for renewal, for example, as indicated by the timestamps included in the entity certificate information transmitted to the update agent 806 at operation 824. In response to the request for new entity certificates, the PKI service 804 may issue new entity certificates for the set of network entities associated with the server network entity 808 (operation 828). The new entity certificates may be issued from the new CA certificate, for example, based on the new CA certificate being the target CA certificate for the server network entity 808 as indicated on the CA certificate target list 640 (FIG. 6C). In one example, the new entity certificates may include a new entity certificate issued for the server network entity 808. Additionally, or alternatively, the new entity certificates may include one or more new entity certificates issued for one or more client network entities serviced by the server network entity 808. Additionally, or alternatively, new entity certificates may include one or more new entity certificates issued for one or more services executing on the server network entity 808 or on a client network entity serviced by the server network entity 808. The PKI service 804 may transmit the new entity certificates to the update agent 806 executing on the server network entity 808 (operation 830).

The update agent 806 may distribute the new entity certificates to the respective network entities associated with the server network entity 808. When the new entity certificates have been transmitted to the update agent 806 and the update agent 806 has distributed to the new entity certificates to the respective network entities, the orchestration service may orchestrate a testing process for performing a set of testing operations in the execution environment pertaining to the new CA certificate (operation 832). The testing process may include one or more operations that utilize, or that pertain to, the new entity certificates. The orchestration service may determine that the new entity certificates have been successfully distributed based on information from the event monitoring service 610 (FIG. 6A).

### C. Selecting a CA Certificate for Issuance of Entity Certificates to Network Entities

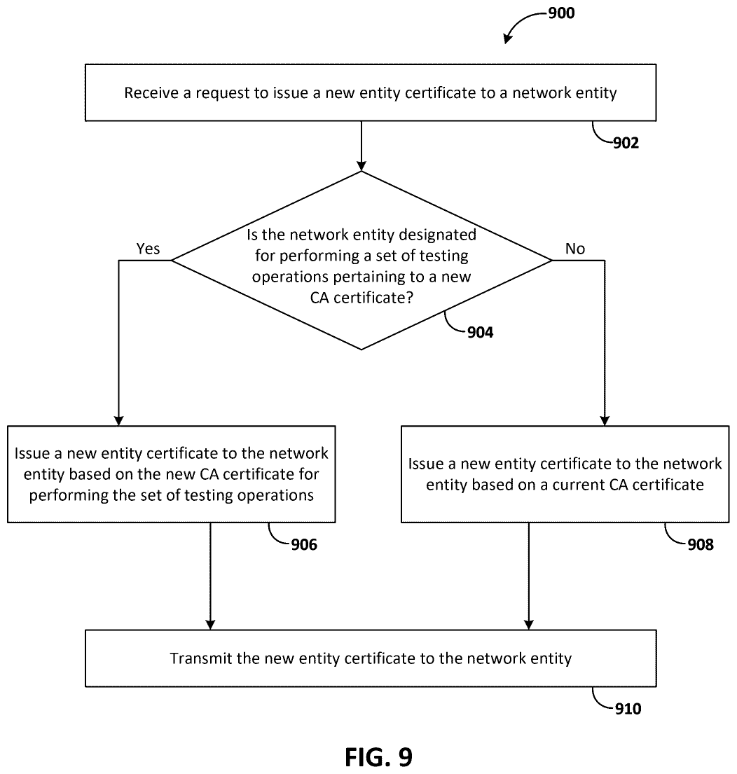

Referring to FIG. 9, example operations 900 pertaining to selecting a CA certificate for issuance of new entity certificates to network entities are further described. One or more operations 900 described with reference to FIG. 9 may be modified, combined, rearranged, or omitted. Accordingly, the particular sequence of operations 900 described with reference to FIG. 9 should not be construed as limiting the scope of one or more embodiments. In one example, the operations described with reference to FIG. 9 may include one or more operations described with reference to FIG. 7 and/or FIG. 8. In one example, the operations 900 may be performed by the one or more components of the system described with reference to FIGS. 6A-6E.

As shown in FIG. 9, a CA certificate may be selected for issuance of a new entity certificate for a network entity based on whether or not the network entity is designated for performing a set of testing operations pertaining to a new CA certificate. In one example, the operations 900 pertaining to selecting a CA certificate for issuance of new entity certificates to network entities may be executed by a PKI service. As shown in FIG. 9, the operations 900 include receiving a request to issue a new entity certificate to a network entity (operation 902). The request may be for a new entity certificate for a particular network entity or for a set of new entity certificates for a set of network entities. In response to the request, the operations 900 include determining whether or not the network entity (or the set of network entities) is designated for performing a set of testing operations pertaining to a new CA certificate. (operation 904). When a network entity is designated for performing the set of testing operations, a new entity certificate may be issued for the network entity from the new CA certificate for performing the set of testing operations (operation 906). When a network entity is not designated for performing the set of testing operations, a new entity certificate may be issued for the network entity from a current CA certificate (operation 908). Upon having issued the new entity certificate(s), the new entity certificate(s) are transmitted to the respective network entity (operation 910). In one example, new entity certificates are transmitted to an update agent executing on a server network entity, and the update module distributes the new entity certificates to the respective client network entities.

In one example, the operations 900 may include determining that a first network entity of a set of network entities executing in the execution environment is designated for performing the set of one or more testing operations (operation 904). Additionally, responsive to determining that the first network entity is designated for performing the set of one or more testing operations, the operations 900 include issuing a first entity certificate for the first network entity based on the new CA certificate (operation 906). The first entity certificate may be distributed to the first network entity for performing the set of one or more testing operations. The set of one or more testing operations are performed with respect to the first network entity based at least in part on the first entity certificate. The set of one or more testing operations may include the operations described with reference to FIG. 10.

In one example, while performing the set of one or more testing operations with respect to the first network entity based at least in part on the first entity certificate, the operations 900 include determining that a second network entity of the set of network entities is not designated for performing the set of one or more testing operations (operation 904). Additionally, responsive to determining that the second network entity is not designated for performing the set of one or more testing operations, the operations 900 include issuing a second entity certificate for the second network entity based on the current CA certificate (operation 908). In one example, the first network entity may be located in a first portion of the execution environment, and the second network entity may be located in a second portion of the execution environment.

In one example, determining that the first network entity is designated for performing the set of one or more testing operations (operation 904) may include accessing a CA certificate target list, and determining, based on the CA certificate target list, that the new CA certificate is designated for use in issuing the first entity certificate for the first network entity. Additionally, or alternatively, determining that the second network entity is not designated for performing the set of one or more testing operations (at operation 904) may include accessing the CA certificate target list, and determining, based on the CA certificate target list, that the current CA certificate is designated for use in issuing the second entity certificate for the second network entity. In one example, the current CA certificate may be identified in the CA certificate target list as being designated for use in issuing the second entity certificate for the second network entity. Alternatively, the current CA certificate and/or the second network entity may be absent from the CA certificate target list, and the determination that the second network entity is not designated for performing the set of one or more testing operations may be based on the absence of the current CA certificate and/or the second network entity from the CA certificate target list.

In one example, responsive to determining that the set of one or more testing operations is successful, the current CA certificate is removed from the execution environment. Upon removing the current CA from the execution environment, the new CA certificate supersedes the current CA certificate. In one example, when the first network entity is located in the first portion of the execution environment and the second network entity is located in the second portion of the execution environment, the operations 900 may include installing the new CA certificate in the second portion of the execution environment. Subsequent to removing the current CA from the execution environment and/or subsequent to installing the new CA certificate, the operations 900 include issuing a third entity certificate based on the new CA certificate for at least one of the following: the first network entity or the second network entity. In one example, subsequent to removing the current CA from the execution environment, the operations 900 include determining that the first network entity is not designated for performing the set of one or more testing operations (operation 904). Responsive to determining that the first network entity is not designated for performing the set of one or more testing operations, the operations 900 include issuing the third entity certificate for the first network entity based on the new CA certificate (operation 908). Additionally, or alternatively, subsequent to removing the current CA from the execution environment, the operations 900 include determining that the second network entity is not designated for performing the set of one or more testing operations (operation 904). Responsive to determining that the second network entity is not designated for performing the set of one or more testing operations, the operations 900 include issuing the third entity certificate for the second network entity based on the new CA certificate (operation 908).

In one example, subsequent to the set of one or more testing operations having been performed with respect to the first network entity, the target CA certificate for the first network entity may be changed from the new CA certificate to the current CA certificate. In one example, the target CA certificate for the first network entity may be changed from the new CA certificate to the current CA certificate while additional testing operations are performed with respect to additional portions of the execution environment. The target CA certificate for the first network entity may be changed from the new CA certificate to the current CA certificate prior to removing the current CA certificate from the execution environment. In one example, subsequent to changing the target CA certificate for the first network entity from the new CA certificate to the current CA certificate, the operations 900 may include issuing a fourth entity certificate for the first network entity based on the current CA certificate. In one example, the fourth entity certificate supersedes the first entity certificate issued for the first network entity based on the new CA certificate.

In one example, an epoch date corresponding to the first entity certificate issued to the network entity may be updated in connection with changing the target CA certificate for the first network entity from the new CA certificate to the current CA certificate. The update to the epoch date may trigger the PKI service to issue a new entity certificate for the first network entity based on the current CA certificate to supersede the entity certificate issued for the first network entity based on the new CA certificate for performing the testing operations. In one example, the operations 900 may include determining, based on the epoch date corresponding to the first entity certificate, that the first entity certificate is in a condition for renewal. Additionally, the operations 900 may include determining, based on the CA certificate target list, that the current CA certificate is the target CA certificate for issuing an entity certificate for the first network entity. The fourth entity certificate may be issued for the first network entity based on the current CA certificate responsive at least in part to determining that the first entity certificate is in the condition for renewal and that the current CA certificate is the target CA certificate for issuing new entity certificates for the first network entity.

### D. Orchestrating Testing Processes in an Execution Environment

Referring to FIG. 10, example operations 1000 pertaining to orchestrating a testing process in an execution environment of a computing network are further described. Orchestration of the testing process may include performing testing operations pertaining to a new CA certificate in the execution environment. One or more operations 1000 described with reference to FIG. 10 may be modified, combined, rearranged, or omitted. Accordingly, the particular sequence of operations 1000 described with reference to FIG. 10 should not be construed as limiting the scope of one or more embodiments. In one example, the operations described with reference to FIG. 10 may include one or more operations described with reference to FIG. 7, FIG. 8, and/or FIG. 9. In one example, the operations 1000 may be performed by the one or more components of the system described with reference to FIGS. 6A-6E.

As shown in FIG. 10, the operations 1000 include installing a new certificate bundle, including a new CA certificate, in a first portion of an execution environment that includes a first network entity and a second network entity (operation 1002). A PKI service may transmit the new certificate bundle to an update module executing on a server network entity, and the update module may install the certificate bundle in a storage medium associated with the server network entity and/or with one or more client network entities serviced by the server network entity. The operations further include issuing new entity certificates from the new CA certificate for the first network entity and the second network entity (operation 1004). The new entity certificates may be transmitted to the respective network entities. The operations 1000 include performing one or more testing operations pertaining to the new CA certificate in the execution environment (operation 1006). Additionally, the operations 1000 include providing one or more test results indicating, for example, that the one or more testing operations are successful (operation 1008). Responsive to determining that the one or more testing operations are successful, the operations 1000 include distributing new entity certificates to network entities in the execution environment (operation 1010) and removing the current CA certificate from the execution environment (operation 1012).

The one or more testing operations (operation 1006) may include executing one or more authentication protocols associated with the new CA certificate. The one or more authentication protocols may include one or more of operation 1012, operation 1014, and/or operation 1016. Additionally, or alternatively, the one or more testing operations (operation 1006) may include one or more network entity validations. The one or more network entity validations may include one or more of operation 1018 and/or operation 1020. Additionally, or alternatively, the one or more testing operations (operation 1006) may include one or more event service validations. The one or more event services validations may include one or more of operation 1022 and/or operation 1024.

### i. Example Authentication Protocol Operations

The one or more testing operations (operation 1006) may include executing one or more authentication protocols associated with the new CA certificate. In one example, an authentication protocol may include receiving, at the first network entity, an entity certificate corresponding to a second network entity executing in the execution environment (operation 1012). Additionally, the authentication protocol may include authenticating the entity certificate against the new CA certificate of the new certificate bundle (operation 1014). Further, the operations 1000 may include determining whether the entity certificate is successfully authenticated via the new CA certificate (operation 1016).

The first network entity may be a server network entity, and the second network entity may be a client network entity serviced by the first network entity. The first network entity may receive the entity certificate from the second network entity for authentication in accordance with a security protocol such as a TLS protocol or an mTLS protocol. The security protocol may be executed prior to executing a communication exchange between the first network entity and the second network entity. In one example, a server network entity receives an entity certificate from a client network entity when the client entity attempts to initiate a connection with the server network entity. The server network entity attempts to authenticate the entity certificate against the new CA certificate prior to completing the connection. Additionally, or alternatively, a client network entity receives an entity certificate from a server network entity (when the client network entity or the server network entity attempts to initiate a connection). The client network entity attempt to authenticate the entity certificate against the new CA certificate prior to completing the connection.

The first network entity may authenticate the entity certificate received from the second network entity by validating a certificate chain that includes the entity certificate and the new CA certificate. The orchestration service may determine that the certificate bundle, the new CA certificate, and/or the new entity certificate are configured correctly when the new certificate is successfully authenticated via the new CA certificate in the certificate bundle. When the new entity certificate is successfully authenticated via the new CA certificate, the operations 1000 may include providing a test result indicating a successful testing operation (operation 1008).

### ii. Example Network Entity Validations

The one or more testing operations (operation 1006) may include performing a set of one or more network entity validations (operation 1018). Additionally, the one or more testing operations (operation 1006) may include determining whether the set of one or more network entity validations are successful (operation 1020). When the set of one or more network entity validations are successful, the operations 1000 may include providing a test result indicating a successful testing operation (operation 1008). The network entity validations may include metadata validations and/or connectivity validations.

In one example, a metadata validation may include validating that the network entity has downloaded and installed the correct certificate bundle for testing. Additionally, or alternatively, a metadata validation may include validating that the certificate bundle includes the correct set of CA certificates, including the new CA certificate. Additionally, or alternatively, a metadata validation may include validating that the correct entity certificate has been distributed to the network entity. An update module executing on the network entity may perform the network entity validations by examining one or more file attributes, or metadata, of a certificate bundle, a CA certificate, and/or an entity certificate.

Additionally, or alternatively, the network entity may perform the metadata validations by comparing a first hash value representing certificate information at the network entity against a second hash value representing certificate information at the PKI service. In one example, the first hash value may represent a certificate bundle and/or one or more CA certificates in the certificate bundle downloaded to the network entity, and the second hash value may represent the certificate bundle and/or the CA certificates in the certificate bundle stored in a certificate repository of the PKI service. Additionally, or alternatively, the first hash value may represent an entity certificate downloaded to the network entity, and the second hash value may represent the entity certificate stored in the certificate repository of the PKI service.

Additionally, or alternatively, the update module executing on the network entity may perform the metadata validations by comparing a first timestamp corresponding to certificate information at the network entity against a second timestamp corresponding to certificate information stored in the certificate repository of the PKI service. In one example, the first timestamp may correspond to a time when the certificate bundle and/or one or more CA certificates in the certificate bundle were downloaded to the network entity, and the second timestamp may correspond to a time when the certificate bundle and/or the CA certificates in the certificate bundle were generated or stored in a certificate repository of the PKI service. Additionally, or alternatively, the first timestamp may correspond to a time when an entity certificate was downloaded to the network entity, and the second timestamp may correspond to a time when the entity certificate was generated or stored in the certificate repository of the PKI service.

The connectivity validations may include validating that an availability parameter meets an availability threshold. The availability parameter may pertain to one or more services executing on a network entity. The availability parameter may be determined for a particular network entity or a set of network entities. In one example, the availability parameter may be determined for a server network entity and a set of client network entities that utilize a service executing on the server network entity. A connectivity validation may be determined successful when an availability parameter meets the availability threshold. A connectivity validation may be determined unsuccessful when an availability threshold is unmet. The availability parameter may represent an availability of a server network entity to accept connection requests from client network entities in accordance with a security protocol such as a TLS protocol. Additionally, or alternatively, the availability parameter may represent an availability of network entities to mutually to accept connection requests and establish connections with one another in accordance with a security protocol such as an mTLS protocol. The availability parameter may be determined and compared to the availability threshold by an agent or application executing on a respective network entity. Additionally, or alternatively, the availability parameter may be determined and compared to the availability threshold by an orchestration service according to an automated process and/or via interactions with an operator via an operator interface.

iii. Example Event Services Validations

The one or more testing operations (operation 1006) may include performing a set of one or more event services validations (operation 1022). Additionally, the one or more testing operations (operation 1006) may include determining whether the set of one or more event services validations are successful (operation 1024). When the set of one or more event services validations are successful, the operations 1000 may include providing a test result indicating a successful testing operation (operation 1008).

The one or more event service validations may include transmitting information from the event monitoring service to the orchestration service. The information from the event monitoring service may include file attributes, hash values, and/or timestamps associated with certificate bundles, CA certificates, and/or entity certificates. The orchestration service may perform one or more testing operations based on information from the event monitoring service. The one or more event service validations may include one or more testing operations performed by the orchestration service based on information from the event monitoring service. The information from the event monitoring service may include file attributes, hash values, and/or timestamps associated with certificate bundles, CA certificates, and/or entity certificates. The orchestration service may validate certificate bundles, CA certificates, and/or entity certificates based on the file attributes, hash values, and/or timestamps included in the information from the event monitoring service.

In one example, the event service validations may be associated with testing operations performed by a network entity. In one example, the information from the event monitoring service may indicate that a network entity has downloaded and installed a certificate bundle for testing. Additionally, or alternatively, the information from the event monitoring service may indicate that the network entity has successfully validated that the correct certificate bundle has been installed, and/or the certificate bundle includes the correct set of CA certificates. Additionally, or alternatively, the orchestration service may utilize the information from the event monitoring service to validate that the correct certificate bundle has been installed, and/or that the certificate bundle includes the correct set of CA certificates. Additionally, or alternatively, the information from the event monitoring service may indicate that the network entity has downloaded one or more entity certificates, and/or that the network entity has successfully authenticated the one or more entity certificates against a corresponding CA certificate. Additionally, or alternatively, the orchestration service may utilize the information from the event monitoring service to validate that the network entity has downloaded one or more entity certificates, and/or that the network entity has successfully authenticated the one or more entity certificates against a corresponding CA certificate.

### 8. Miscellaneous; Extensions

Embodiments are directed to a system with one or more devices that include a hardware processor and that are configured to perform any of the operations described herein and/or recited in any of the claims below. Embodiments are directed to a system that includes means to perform any of the operations described herein and/or recited in any of the claims below. In an embodiment, a non-transitory, computer-readable storage medium comprises instructions that, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of patent protection, and what is intended by the applicants to be the scope of patent protection, is the literal and equivalent scope of the set of claims that issue from this application in the specific form that such claims issue, including any subsequent correction.

References, including publications, patent applications, and patents, cited herein are hereby incorporated by reference to the same extent as if the references were individually and specifically indicated to be incorporated by reference and were set forth in entirety herein.

What is claimed is:

1. One or more non-transitory computer-readable media storing instructions that, when executed by one or more hardware processors, cause performance of operations comprising:
receiving a new certificate authority (CA) certificate for installation in an execution environment of a virtual cloud network to supersede a current CA certificate installed in the execution environment;
orchestrating a testing process for performing a set of one or more testing operations in the execution environment pertaining to the new CA certificate prior to the new CA certificate superseding the current CA certificate, wherein orchestrating the testing process comprises:
determining that a first network entity, of a set of network entities executing in the execution environment, is designated for performing the set of one or more testing operations,
responsive to determining that the first network entity is designated for performing the set of one or more testing operations, issuing a first entity certificate for the first network entity based on the new CA certificate,
distributing the first entity certificate to the first network entity for performing the set of one or more testing operations, wherein the set of one or more testing operations are performed with respect to the first network entity based at least in part on the first entity certificate,
while performing the set of one or more testing operations with respect to the first network entity based at least in part on the first entity certificate:
determining that a second network entity, of the set of network entities, is not designated for performing the set of one or more testing operations,
issuing a second entity certificate for the second network entity based on the current CA certificate,
responsive to determining that the set of one or more testing operations is successful:
issuing a third entity certificate based on the new CA certificate for the second network entity, and
removing the current CA certificate from the execution environment, wherein the new CA certificate supersedes the current CA certificate.

2. The one or more non-transitory computer-readable media of claim 1, wherein the operations further comprise:
maintaining the new CA certificate and the current CA certificate in an active state in the execution environment at least by:
storing the new CA certificate and the current CA certificate in a certificate repository for issuance of new entity certificates;
issuing the first entity certificate based on the new CA certificate stored in the certificate repository while the current CA certificate is stored in the certificate repository; and
issuing the second entity certificate based on the current CA certificate stored in the certificate repository while the new CA certificate is stored in the certificate repository.

3. The one or more non-transitory computer-readable media of claim 1, wherein during the testing process:
the first network entity transmits the first entity certificate to a third network entity for authentication against the new CA certificate, and
the second network entity transmits the second entity certificate to a fourth network entity for authentication against the current CA certificate.

4. The one or more non-transitory computer-readable media of claim 1, wherein orchestrating the testing process comprises:
installing the new CA certificate in a first portion of the execution environment, wherein the first network entity is located in the first portion of the execution environment;
wherein the current CA certificate is installed in a second portion of the execution environment while performing the set of one or more testing operations with respect to the first network entity.

5. The one or more non-transitory computer-readable media of claim 4, wherein the operations further comprise:
responsive to determining that the set of one or more testing operations is successful: installing the new CA certificate in the second portion of the execution environment, wherein the second network entity is located in the second portion of the execution environment.

6. The one or more non-transitory computer-readable media of claim 1, wherein determining that the first network entity is designated for performing the set of one or more testing operations comprises:
accessing a CA certificate target list;
determining, based on the CA certificate target list, that the new CA certificate is designated for use in issuing the first entity certificate for the first network entity.

7. The one or more non-transitory computer-readable media of claim 6, wherein determining that the second network entity is not designated for performing the set of one or more testing operations comprises:
accessing the CA certificate target list;
determining, based on the CA certificate target list, that the current CA certificate is designated for use in issuing the second entity certificate for the second network entity.

8. The one or more non-transitory computer-readable media of claim 1, wherein issuing the first entity certificate for the first network entity based on the new CA certificate responsive to determining that the first network entity is designated for performing the set of one or more testing operations comprises:
accessing a CA certificate target list;
determining, based on the CA certificate target list, that the new CA certificate is designated for use in issuing the first entity certificate for the first network entity;
responsive to determining that the new CA certificate is designated for use in issuing the first entity certificate for the first network entity:
modifying an epoch date to place in a condition for renewal, a fourth entity certificate having been issued for the first network entity based on the current CA certificate;
subsequent to modifying the epoch date to place the fourth entity certificate in the condition for renewal:
receiving a request to issue a new entity certificate for the first network entity;
issuing the first entity certificate for the first network entity based on the new CA certificate.

9. The one or more non-transitory computer-readable media of claim 1, wherein the operations further comprise:
while performing the set of one or more testing operations with respect to the first network entity based at least in part on the first entity certificate:
determining, based on an epoch date corresponding to a fourth entity certificate having been issued for the second network entity based on the current CA certificate, that the fourth entity certificate is in a condition for renewal;
issuing the second entity certificate for the second network entity based on the current CA certificate responsive at least in part to determining that the fourth entity certificate is in the condition for renewal, wherein the second entity certificate supersedes the fourth entity certificate.

10. The one or more non-transitory computer-readable media of claim 1, wherein orchestrating the testing process further comprises:
subsequent to the set of one or more testing operations having been performed with respect to the first network entity based at least in part on the first entity certificate, and prior to removing the current CA certificate from the execution environment:
issuing a fourth entity certificate for the first network entity based on the current CA certificate, wherein the fourth entity certificate supersedes the first entity certificate.

11. The one or more non-transitory computer-readable media of claim 10, wherein issuing the fourth entity certificate for the first network entity based on the current CA certificate comprises:
determining, based on an epoch date corresponding to the first entity certificate, that the first entity certificate is in a condition for renewal;
determining, based on a CA certificate target list, that the current CA certificate is designated for use in issuing the fourth entity certificate for the first network entity, the CA certificate target list and the epoch date corresponding to the first entity certificate having been updated subsequent to issuing the first entity certificate based on the new CA certificate;
issuing the fourth entity certificate for the first network entity based on the current CA certificate responsive at least in part to determining that (a) the first entity certificate is in the condition for renewal and (b) that the current CA certificate is designated for use in issuing new entity certificates for the first network entity.

12. A method, comprising:
receiving a new certificate authority (CA) certificate for installation in an execution environment of a virtual cloud network to supersede a current CA certificate installed in the execution environment;
orchestrating a testing process for performing a set of one or more testing operations in the execution environment pertaining to the new CA certificate prior to the new CA certificate superseding the current CA certificate, wherein orchestrating the testing process comprises:
determining that a first network entity, of a set of network entities executing in the execution environment, is designated for performing the set of one or more testing operations,
responsive to determining that the first network entity is designated for performing the set of one or more testing operations, issuing a first entity certificate for the first network entity based on the new CA certificate,
distributing the first entity certificate to the first network entity for performing the set of one or more testing operations, wherein the set of one or more testing operations are performed with respect to the first network entity based at least in part on the first entity certificate,
while performing the set of one or more testing operations with respect to the first network entity based at least in part on the first entity certificate:
determining that a second network entity, of the set of network entities, is not designated for performing the set of one or more testing operations,
issuing a second entity certificate for the second network entity based on the current CA certificate,
responsive to determining that the set of one or more testing operations is successful:
issuing a third entity certificate based on the new CA certificate for the second network entity, and
removing the current CA certificate from the execution environment, wherein the new CA certificate supersedes the current CA certificate;
wherein the method is performed by at least one device including a hardware processor.

13. The method of claim 12, further comprising:
maintaining the new CA certificate and the current CA certificate in an active state in the execution environment at least by:
storing the new CA certificate and the current CA certificate in a certificate repository for issuance of new entity certificates;
issuing the first entity certificate based on the new CA certificate stored in the certificate repository while the current CA certificate is stored in the certificate repository; and
issuing the second entity certificate based on the current CA certificate stored in the certificate repository while the new CA certificate is stored in the certificate repository.

14. The method of claim 12, wherein during the testing process:
the first network entity transmits the first entity certificate to a third network entity for authentication against the new CA certificate, and
the second network entity transmits the second entity certificate to a fourth network entity for authentication against the current CA certificate.

15. The method of claim 12, wherein orchestrating the testing process comprises:
installing the new CA certificate in a first portion of the execution environment, wherein the first network entity is located in the first portion of the execution environment;
wherein the current CA certificate is installed in a second portion of the execution environment while performing the set of one or more testing operations with respect to the first network entity.

16. The method of claim 12, wherein determining that the first network entity is designated for performing the set of one or more testing operations comprises:
accessing a CA certificate target list;
determining, based on the CA certificate target list, that the new CA certificate is designated for use in issuing the first entity certificate for the first network entity.

17. The method of claim 12, wherein issuing the first entity certificate for the first network entity based on the new CA certificate responsive to determining that the first network entity is designated for performing the set of one or more testing operations comprises:
accessing a CA certificate target list;
determining, based on the CA certificate target list, that the new CA certificate is designated for use in issuing the first entity certificate for the first network entity;
responsive to determining that the new CA certificate is designated for use in issuing the first entity certificate for the first network entity:
modifying an epoch date to place in a condition for renewal, a fourth entity certificate having been issued for the first network entity based on the current CA certificate;
subsequent to modifying the epoch date to place the fourth entity certificate in the condition for renewal:
receiving a request to issue a new entity certificate for the first network entity;
issuing the first entity certificate for the first network entity based on the new CA certificate.

18. The method of claim 12, further comprising:
while performing the set of one or more testing operations with respect to the first network entity based at least in part on the first entity certificate:
determining, based on an epoch date corresponding to a fourth entity certificate having been issued for the second network entity based on the current CA certificate, that the fourth entity certificate is in a condition for renewal;
issuing the second entity certificate for the second network entity based on the current CA certificate responsive at least in part to determining that the fourth entity certificate is in the condition for renewal, wherein the second entity certificate supersedes the fourth entity certificate.

19. The method of claim 12, wherein orchestrating the testing process further comprises:
subsequent to the set of one or more testing operations having been performed with respect to the first network entity based at least in part on the first entity certificate, and prior to removing the current CA certificate from the execution environment:
issuing a fourth entity certificate for the first network entity based on the current CA certificate, wherein the fourth entity certificate supersedes the first entity certificate.

20. A system, comprising:
at least one hardware processor;
wherein the system is configured to execute operations, using the at least one hardware processor, the operations comprising:
receiving a new certificate authority (CA) certificate for installation in an execution environment of a virtual cloud network to supersede a current CA certificate installed in the execution environment;
orchestrating a testing process for performing a set of one or more testing operations in the execution environment pertaining to the new CA certificate prior to the new CA certificate superseding the current CA certificate, wherein orchestrating the testing process comprises:
determining that a first network entity, of a set of network entities executing in the execution environment, is designated for performing the set of one or more testing operations,
responsive to determining that the first network entity is designated for performing the set of one or more testing operations, issuing a first entity certificate for the first network entity based on the new CA certificate,
distributing the first entity certificate to the first network entity for performing the set of one or more testing operations, wherein the set of one or more testing operations are performed with respect to the first network entity based at least in part on the first entity certificate,
while performing the set of one or more testing operations with respect to the first network entity based at least in part on the first entity certificate:
determining that a second network entity, of the set of network entities, is not designated for performing the set of one or more testing operations,
issuing a second entity certificate for the second network entity based on the current CA certificate,
responsive to determining that the set of one or more testing operations is successful:
issuing a third entity certificate based on the new CA certificate for the second network entity, and
removing the current CA certificate from the execution environment, wherein the new CA certificate supersedes the current CA certificate.
